(19) United States
(12) Patent Application Publication
(10) Pub. No.: US 2025/0353722 A1
(43) Pub. Date: Nov. 20, 2025

(54) BOTTOM-LOADED WATER DISPENSER

(71) Applicants: FOSHAN SHUNDE MIDEA WATER DISPENSER MANUFACTURING CO., LTD., Foshan (CN); MIDEA GROUP CO., LTD., Foshan (CN)

(72) Inventors: Sipei Hong, Foshan (CN); Baoyou Cheng, Foshan (CN)

(73) Assignees: FOSHAN SHUNDE MIDEA WATER DISPENSER MANUFACTURING CO., LTD., Foshan (CN); MIDEA GROUP CO., LTD., Foshan (CN)

(21) Appl. No.: 18/999,255

(22) Filed: Dec. 23, 2024

Related U.S. Application Data
(63) Continuation of application No. PCT/CN2024/128641, filed on Oct. 30, 2024.

(30) Foreign Application Priority Data
May 15, 2024 (CN) 202410607011.X
May 15, 2024 (CN) 202410607754.7
May 15, 2024 (CN) 202421065924.5
May 15, 2024 (CN) 202421066041.6

(51) Int. Cl. B67D 1/00; B67D 1/08

(52) U.S. Cl. CPC B67D 1/0004; B67D 1/0857; B67D 1/0895; B67D 2001/0097

(57) ABSTRACT

Provided is a bottom-loaded water dispenser. The bottom-loaded water dispenser includes a functional module and a second cavity disposed below the functional module. The second cavity is adapted to receive a water bucket. The functional module includes a cooling tank assembly, a heating tank assembly, a water passageway assembly, and a water pump. The cooling tank assembly and the heating tank assembly are connected to the water passageway assembly. The water pump is configured to pump water in the water bucket to the water passageway assembly.

### CROSS-REFERENCE TO RELATED APPLICATIONS

This application is a continuation of International Application No. PCT/CN2024/128641, filed on Oct. 30, 2024, which claims priorities to Chinese Patent application Ser. No. 202410607011.X, Chinese Patent Application No. 202421066041.6, Chinese patent application Ser. No. 202410607754.7, and Chinese Patent Application No. 202421065924.5 that are all filed on May 15, 2024, the entire contents of each of which are hereby incorporated by reference. No new matter has been introduced.

### FIELD

The present disclosure relates to the technical field of drinking water devices, and in particular, to a bottom-loaded water dispenser.

### BACKGROUND

In the related technology, since different bottom-loaded water dispensers have different operation process routes and different appearance structures, internal structures of the bottom-loaded water dispensers tend to different and have significant differences, making it impossible to achieve universality, and increasing manufacturing costs.

### SUMMARY

The bottom-loaded water dispenser according to the embodiments of the present disclosure includes a functional module and a second cavity disposed below the functional module. The second cavity is adapted to receive a water bucket. The functional module includes a cooling tank assembly; a heating tank assembly; a water passageway assembly. The cooling tank assembly and the heating tank assembly are connected to the water passageway assembly. The water pump is configured to pump water in the water bucket to the water passageway assembly.

### BRIEF DESCRIPTION OF THE DRAWINGS

FIG. 1 is a perspective view of a bottom-loaded water dispenser according to an embodiment of the present disclosure.

FIG. 2 is an exploded view of a bottom-loaded water dispenser according to an embodiment of the present disclosure.

FIG. 3 is a schematic assembly view of a bottom-loaded water dispenser according to an embodiment of the present disclosure.

FIG. 4 is a rear view of a bottom-loaded water dispenser according to an embodiment of the present disclosure.

FIG. 5 is an enlarged view at part C in FIG. 3.

FIG. 6 is a perspective view of a bottom-loaded water dispenser according to an embodiment of the present disclosure, in which a housing is not shown.

FIG. 7 is a schematic view of a functional module of a bottom-loaded water dispenser according to an embodiment of the present disclosure.

FIG. 8 is an exploded view of a bottom-loaded water dispenser according to an embodiment of the present disclosure, in which a housing is not shown.

FIG. 9 is a perspective view of a functional module and a water pump of a bottom-loaded water dispense according to an embodiment of the present disclosure.

FIG. 10 is a cross-sectional view of a functional module of a bottom-loaded water dispenser according to an embodiment of the present disclosure.

FIG. 11 is a cross-sectional view of a functional module of a bottom-loaded water dispenser according to an embodiment of the present disclosure from another angle.

FIG. 12 is a perspective view of a first manifold of a bottom-loaded water dispenser according to an embodiment of the present disclosure.

FIG. 13 is a perspective view of a first manifold of a bottom-loaded water dispenser according to an embodiment of the present disclosure from another viewing angle.

FIG. 14 is a perspective view of a first manifold of a bottom-loaded water dispenser (that shows a first connection portion and a fifth connection portion) according to an embodiment of the present disclosure.

FIG. 15 is a perspective view of a cover plate of a bottom-loaded water dispenser according to an embodiment of the present disclosure.

FIG. 16 is a perspective view of a cover plate of a bottom-loaded water dispenser according to an embodiment of the present disclosure from another viewing angle.

FIG. 17 is a perspective view of a second manifold of a bottom-loaded water dispenser according to an embodiment of the present disclosure.

FIG. 18 is a schematic view of a heating tank assembly of a bottom-loaded water dispenser according to an embodiment of the present disclosure.

FIG. 19 is a schematic view of a cooling tank assembly of a bottom-loaded water dispenser according to an embodiment of the present disclosure.

FIG. 20 is a schematic view of a top structure of a cooling tank assembly of a bottom-loaded water dispenser according to an embodiment of the present disclosure.

FIG. 21 is an exploded view of a cooling tank assembly of a bottom-loaded water dispenser according to an embodiment of the present disclosure.

FIG. 22 is a schematic view of a passageway and an air passage of a bottom-loaded water dispenser according to an embodiment of the present disclosure.

FIG. 23 is a schematic view of a three-way tube of a bottom-loaded water dispenser according to an embodiment of the present disclosure.

FIG. 24 is a schematic view of an engagement of two connected components in an insertion manner (the two connected in the insertion manner) of a bottom-loaded water dispenser according to an embodiment of the present disclosure.

FIG. 25 is a schematic view of a sealing member of a bottom-loaded water dispenser according to an embodiment of the present disclosure.

### REFERENCE NUMERALS

100, bottom-loaded water dispenser;
10, housing; 11, through hole; 12, bottom plate; 13, upper cover; 14, first side plate; 15, second side plate; 16, front housing; 17, rear housing; 18, door body; 181, gate switch; 10a, first cavity; 10b, second cavity; 19, hook slot;
20, functional module; 21, cooling tank assembly; 211, cooling tank; 212, heat preservation member; 213, refrigeration member; 22, heating tank assembly; 23, water passageway assembly; 231, water outlet manifold; 24, cover plate; 241, connection tube; 25, compressor; 26, condenser; 5100 cold-tank water inlet connector; 5200, cooling-tank water outlet connector; 5300, cooling-tank drainage connector; 5400, cooling-tank exhaust connector; 5610, third connection portion; 5620, fourth connection portion; 6100, heating-tank water inlet and drainage connector; 6200, heating-tank water outlet connector; 6300, heating-tank exhaust connector; 6400, sixth connection portion;
30, first manifold; 31, water receiving basin; 32, water inlet passageway; 33, water outlet passageway; 34, water outlet; 35, exhaust passageway; 36, water supply passageway; 311, first partitioning member; 312, second partitioning member; 321, first water inlet passageway; 322, second water inlet passageway; 331, first water outlet passageway; 332, second water outlet passageway; 333, third water outlet passageway; 341, first water outlet; 342, second water outlet; 343, third water outlet; 351, first air passageway; 352, second air passageway; 353, first exhaust region; 354, second exhaust region; 3211, first water inlet connector; 3221, second water inlet connector; 3311, first water outlet connector; 3321, second water outlet connector; 3411, first exhaust connector; 3421, second exhaust connector; 3510, first connection portion; 3520, fifth connection portion;
40, second manifold; 41, drainage passageway; 411, first drainage passageway; 412, second drainage passageway; 42, openable member; 4111, first drainage connector; 4121, second drainage connector; 4200, second connection portion;
50, water pump; 51, water bucket; 1100, first water delivery hose; 1200, second water delivery hose;
60, support; 61, hook;
70, three-way tube; 71, first port; 72, second port; 73, third port;
80, water outlet member; 81, water collection box;
91, water outlet fixing cover; 92, water outlet connector; 921, cold water faucet; 922, hot water faucet; 923, normal temperature water faucet; 93, display assembly; 94, electric control box; 95, first switch; 96, second switch;
8000, sealing member; 8100, first annular wall; 8200, second annular wall; 8300, sandwiched cavity.

### DETAILED DESCRIPTION

Embodiments of the present disclosure will be described in detail below, examples of which are illustrated in the accompanying drawings. The embodiments described below with reference to the accompanying drawings are illustrative, and are intended to explain rather than be understood as limiting the present disclosure.

In descriptions of the present disclosure, it needs to be understood that the orientation or the position indicated by terms such as “over”, “top”, “bottom”, “inner”, and “outer” is based on the orientation or position relationship shown in the accompanying drawings, and is merely for the convenience of describing the present disclosure and simplifying the description, rather than indicating or implying that the associated device or element must have a specific orientation, or be constructed and operated in a specific orientation, and therefore cannot be understood as a limitation on the present disclosure.

In addition, the terms “first” and “second” are only used for descriptive purposes, and cannot be understood as indicating or implying relative importance or implicitly indicating the number of indicated technical features. Therefore, the features associated with “first” or “second” can explicitly or implicitly include at least one of the features. In the description of the present disclosure, “plurality” means at least two, such as two, three, etc., unless otherwise specifically defined.

In the present disclosure, unless otherwise clearly specified and limited, terms such as “mount”, “connect”, “connect to”, “fix” and the like should be understood in a broad sense. For example, unless otherwise specifically defined, it may be a fixed connection or a detachable connection or connection as one piece; mechanical connection or electrical connection or communicable with each other; direct connection or indirect connection through an intermediate; internal communication of two components or the interaction relationship between two components. For those of ordinary skill in the art, the specific meanings of the above terms in the present disclosure can be interpreted depending on specific situations.

A bottom-loaded water dispenser 100 in the embodiments of the present disclosure is described below with reference to the accompanying drawings.

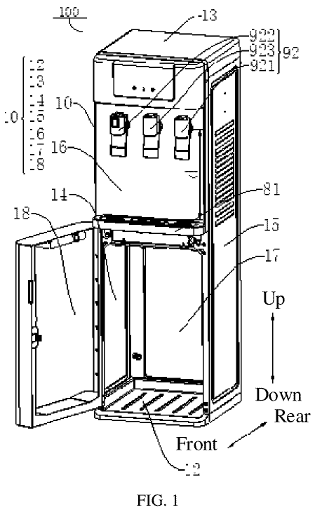

As shown in FIG. 1 to FIG. 9, the bottom-loaded water dispenser 100 according to the embodiments of the present disclosure includes a functional module 20 and a second cavity 10b disposed below the functional module 20.

In an exemplary embodiment of the present disclosure, the second cavity 10b is adapted to receive a water bucket 51. The functional module 20 includes a cooling tank assembly 21, a heating tank assembly 22, a water passageway assembly 23, and a water pump 50. The cooling tank assembly 21 and the heating tank assembly 22 are connected to the water passageway assembly 23. The water pump 50 is configured to pump water in the water bucket 51 to the water passageway assembly 23.

With the bottom-loaded water dispenser 100 according to the embodiments of the present disclosure, the functional module 20 includes the cooling tank assembly 21, the heating tank assembly 22, and the water passageway assembly 23. The cooling tank assembly 21 and the heating tank assembly 22 are connected to the water passageway assembly 23. The water bucket 51 in the second cavity 10b is in communication with the water passageway assembly 23 through the water pump 50. In this way, heating and cooling of water can be realized, to meet the required water usage needs, which is beneficial for enhancing the user's experience. Furthermore, the functional module 20 integrates the cooling tank assembly 21, the heating tank assembly 22, the water passageway assembly 23, and the water pump 50 into a whole, which facilitates realization of overall mounting of the functional module 20 and expansion of the bottom-loaded water dispenser 100 in shape and color, is conducive to realization of producing bottom-loaded water dispensers 100 with different appearances, is helpful to improve a structural universality rate and an automation coverage rate, and can lead to a reduction in labor hours and manufacturing costs. Meanwhile, a functional check may be performed on the integrated functional module 20 in advance, to avoid problems such as the need for disassembly and rework after the mounting of the bottom-loaded water dispenser 100 is completed.

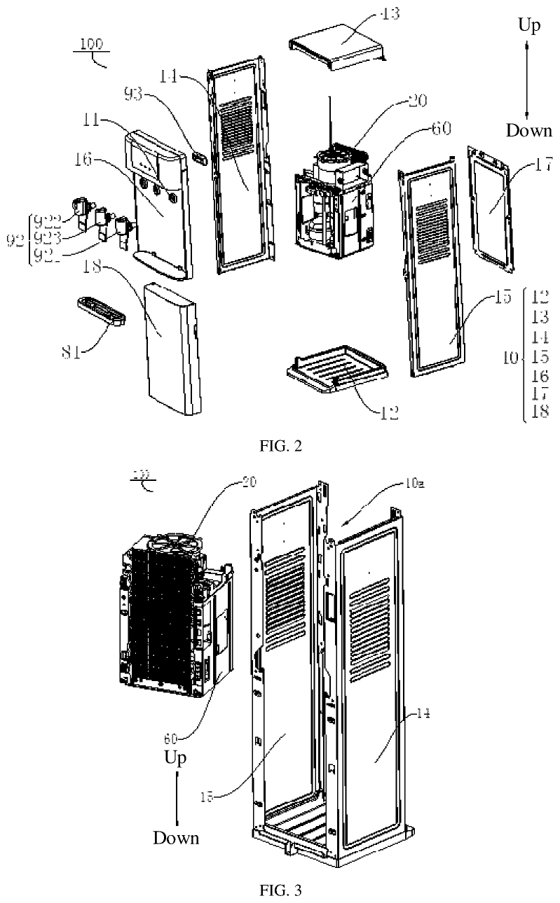

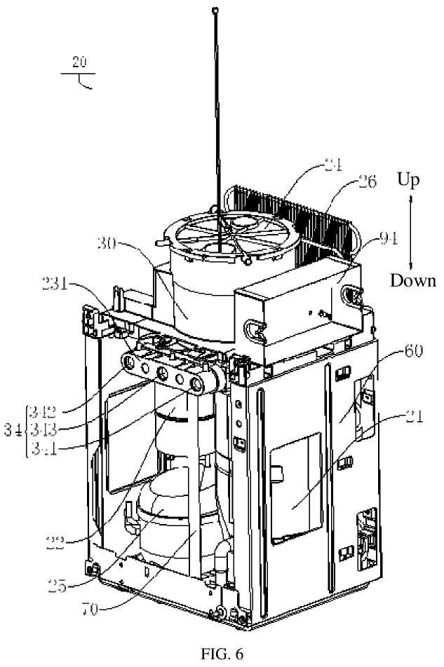

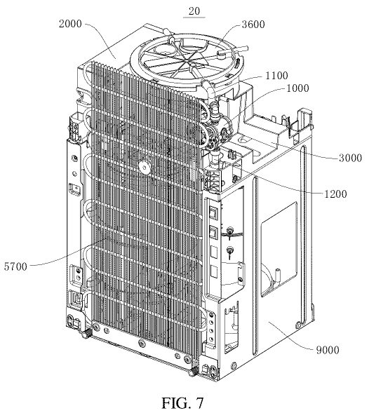

In some embodiments of the present disclosure, as shown in FIG. 1, FIG. 2, and FIG. 6 to FIG. 9, the bottom-loaded water dispenser 100 includes a housing 10, a support 60, the functional module 20, and the water pump 50.

In an exemplary embodiment of the present disclosure, as shown in FIG. 1 to FIG. 4, the housing 10 has a first cavity 10a and the second cavity 10b that are spaced apart from each other. The first cavity 10a is located above the second cavity 10b, and the water bucket 51 is adapted to be disposed in the second cavity 10b. The support 60 is disposed in the first cavity 10a and connected to the housing 10. The functional module 20 is located in the first cavity 10a and integrated on the support 60.

It can be understood that the functional module 20 may be protected by the housing 10 to prevent external structures from damaging the functional module 20, which is beneficial to prolong a service life of the bottom-loaded water dispenser 100 and ensure an aesthetically pleasing appearance. The support 60 is provided, which can realize a connection between the functional module 20 and the housing 10, ensuring that the functional module 20 is reliably fixed in the housing 10. Moreover, the functional module 20 may be collectively mounted on the support 60. Then, the functional module 20 and the support 60 are entirely mounted in the housing 10. In this way, it is convenient to realize the overall mounting of the functional module 20, and it is beneficial to realize mechanical automation production, improving production efficiency. In addition, the functional check may be performed on the integrated functional module 20 in advance to avoid the problems such as the need for disassembly and rework after the mounting of the bottom-loaded water dispenser 100 is completed.

As shown in FIG. 6 to FIG. 9, the functional module 20 includes the cooling tank assembly 21, the heating tank assembly 22, and the water passageway assembly 23. The cooling tank assembly 21 and the heating tank assembly 22 are connected to the water passageway assembly 23. The water passageway assembly 23 has a water outlet 34. Meanwhile, the water pump 50 is configured to pump the water in the water bucket 51 to the water passageway assembly 23. The water pump 50 may provide a driving force, whereby the water in the water bucket 51 located in the second cavity 10b may enter the water passageway assembly 23 located in the first cavity 10a through the water pump 50, enter the cooling tank assembly 21 and/or the heating tank assembly 22 through the water passageway assembly 23, then be heated by the heating tank assembly 22 and cooled by the cooling tank assembly 21, and flow out of the water outlet 34, which can to meet the required water usage needs and is beneficial for enhancing the user's experience.

In addition, the functional module 20 may be formed as a basic definition platform, which facilitates the expansion of the housing 10 in shape and color, can realize the production of bottom-loaded water dispensers 100 with different appearances, is conducive to improve the structural universality rate and the automation coverage rate, and can lead to a reduction in labor hours and manufacturing costs. For example, the bottom-loaded water dispenser 100 of the present disclosure may achieve an increase of 40% in a parts universality rate index, an increase in the automation coverage rate to 50%, and a reduction of 15% in cost.

In some embodiments, a structure of the functional module 20 (such as the cooling tank assembly 21, the heating tank assembly 22, or the water passageway assembly 23) may be selectively configured in specification as different requirements, which can realize production of bottom-loaded water dispensers 100 with different performances, satisfying different usage requirements.

It needs to be noted that as shown in FIG. 1 and FIG. 2, the housing 10 includes an upper cover 13, a bottom plate 12, a first side plate 14, a second side plate 15, a front housing 16, a rear housing 17, and a door body 18. Two ends of the first side plate 14 in a length direction of the first side plate 14 are connected to the upper cover 13 and the bottom plate 12, respectively. Two ends of the second side plate 15 in a length direction of the second side plate 15 are connected to the upper cover 13 and the bottom plate 12, respectively. In addition, the first side plate 14 and the second side plate 15 are located at two opposite sides of the bottom plate 12, respectively. The front housing 16 is located at one of a side of the first side plate 14 in a width direction of the first side plate 14 and a side of the second side plate 15 in a width direction of the second side plate 15. The rear housing 17 is located at another one of the side of the first side plate 14 in the width direction of the first side plate 14 and the side of the second side plate 15 in the width direction of the second side plate 15. The front housing 16 is connected to each of the first side plate 14, the second side plate 15, and the upper cover 13. The front housing 16 is opposite to the first cavity 10a and is spaced apart from the bottom plate 12. The rear housing 17 is connected to each of the first side plate 14, the second side plate 15, and the bottom plate 12. The rear housing 17 is opposite to the second cavity 10b and is spaced apart from the upper cover 13. The door body 18 is opposite to the rear housing 17 for exposing or covering the second cavity 10b. A gate switch 181 may also be provided on the door body 18 for controlling the door body 18 to expose or cover the second cavity 10b.

Through a structural design of the housing 10 as described above, it is convenient for the housing 10 to form the first cavity 10a and the second cavity 10b for respectively placing the functional module 20 and the water bucket 51, with a reasonable structural design and a compact arrangement. The housing 10 may form an integral frame, which is beneficial to improve a structural strength of the housing 10, to ensure a protection effect on structures such as the functional module 20 and the water bucket 51, and is beneficial to improve the service life of the bottom-loaded water dispenser 100 and an aesthetic degree of an appearance of the bottom-loaded water dispenser 100.

The functional module 20 is located in the first cavity 10a of the housing 10 and includes the cooling tank assembly 21, the heating tank assembly 22, and the water passageway assembly 23. The cooling tank assembly 21 and the heating tank assembly 22 are connected to the water passageway assembly 23. The water bucket 51 in the second cavity 10b is in communication with the water passageway assembly 23 through the water pump 50. The water passageway assembly 23 has the water outlet 34. In this way, the heating and cooling of water can be realized, to meet the required water usage needs, which is beneficial for enhancing the user's experience. In addition, the functional module 20 is integrated and disposed on the support 60 in the first cavity 10a, and the support 60 is connected to the housing 10, which facilitates the realization of the overall mounting of the functional module 20 and the expansion of the housing 10 in shape and color, can realize the production of the bottom-loaded water dispensers 100 with different appearances, is beneficial to improve the structural universality rate and the automation coverage rate, and can lead to a reduction in labor hours and manufacturing costs. Meanwhile, the functional check may be performed on the integrated functional module 20 in advance, to avoid the problems such as the need for disassembly and rework after the mounting of the bottom-loaded water dispenser 100 is completed.

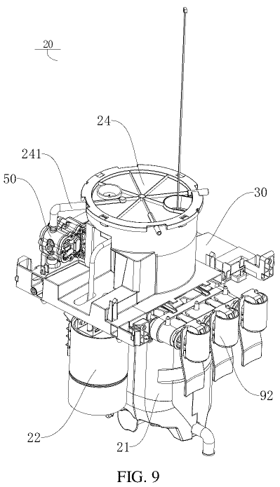

In some embodiments of the present disclosure, as shown in FIG. 9, the water pump 50 is located in the first cavity 10a and connected to at least one of the water passageway assembly 23 and the support 60. The water pump 50 is located in the first cavity 10a, which facilitates pumping the water in the water bucket 51 into the water passageway assembly 23 located in the first cavity 10a, while facilitating the mounting of the water pump 50, to ensure the reliable fixation of the water pump 50 in the housing 10. The water pump 50 may be mounted on the water passageway assembly 23 and/or the support 60, and then the water pump 50, the functional module 20 having the water passageway assembly 23, and the support 60 may be entirely mounted in the housing 10, which is beneficial to realize mechanical automatic production and mounting, improving the production efficiency.

In some embodiments of the present disclosure, as shown in FIG. 6 to FIG. 11 and FIG. 22, the water passageway assembly 23 includes a first manifold 30. The first manifold 30 has a water receiving basin 31, a water inlet passageway 32, a water outlet passageway 33, and the water outlet 34. The water bucket 51 is in communication with the water receiving basin 31. The water receiving basin 31 is in communication with the cooling tank assembly 21 through the water inlet passageway 32, and the water receiving basin 31 is in communication with the heating tank assembly 22 through the water inlet passageway 32, which allows the water bucket 51 to supply water to the cooling tank assembly 21 and the heating tank assembly 22 through the water receiving basin 31 and the water inlet passageway 32, achieving required water supply requirements. In addition, the water outlet 34 is in communication with the cooling tank assembly 21 through the water outlet passageway 33, and the water outlet 34 is in communication with the heating tank assembly 22 through the water outlet passageway 33, which allows water in the cooling tank assembly 21 and the water in the heating tank assembly 22 to flow out of the water outlet 34 through the water outlet passageway 33, realizing the required water using requirements.

Therefore, by integrating the water inlet passageway 32 and the water outlet passageway 33 into the first manifold 30, it is convenient to realize a water inlet function and a water outlet function of the bottom-loaded water dispenser 100, and reliability of the water passageway assembly 23 can be improved. Compared with a connection realized by a silicone tube in the related technology, the first manifold 30 in the present disclosure has a reliable connection and a high structural strength, which is beneficial to prolong its service life, can improve assembly efficiency of the bottom-loaded water dispenser 100, and is beneficial to improve the production efficiency.

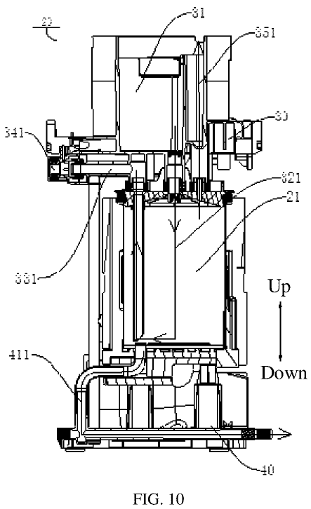

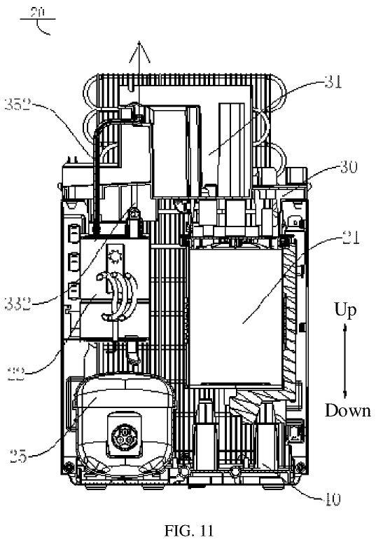

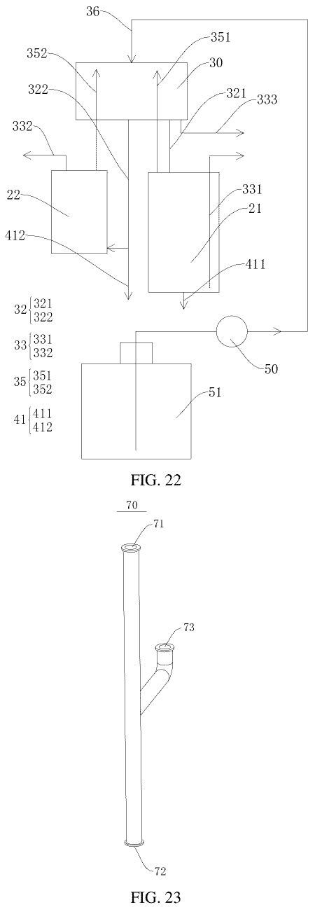

According to some embodiments of the present disclosure, as shown in FIG. 10, FIG. 11, and FIG. 22, the water inlet passageway 32 includes a first water inlet passageway 321 and a second water inlet passageway 322. The water outlet passageway 33 includes a first water outlet passageway 331 and a second water outlet passageway 332. A plurality of water outlets 34 are provided and include a first water outlet 341 and a second water outlet 342. The water receiving basin 31 is in communication with the cooling tank assembly 21 through the first water inlet passageway 321. The water receiving basin 31 is in communication with the heating tank assembly 22 through the second water inlet passageway 322. In this way, by using two independent passageways, i.e., the first water inlet passageway 321 and the second water inlet passageway 322, it is realized that the water is respectively supplied to the cooling tank assembly 21 and the heating tank assembly 22 from one source (the water receiving basin 31) as needs, which facilitates realization of water cooling and heating requirements of the bottom-loaded water dispenser 100, and ensures flexibility and efficiency of temperature control of the bottom-loaded water dispenser 100.

In addition, as shown in FIG. 22, the first water outlet 341 is in communication with the cooling tank assembly 21 through the first water outlet passageway 331, and the second water outlet 342 is in communication with the heating tank assembly 22 through the second water outlet passageway 332, allowing the water in the cooling tank assembly 21 and the water in the heating tank assembly 22 to flow out respectively through the independent first water outlet passageway 331 and the independent second water outlet passageway 332, to avoid occurring an interference between the water drained from the cooling tank assembly 21 and the water drained from the heating tank assembly 22, satisfying required water outlet requirements and reflecting high efficiency and flexibility of the bottom-loaded water dispenser 100 in water temperature management and distribution.

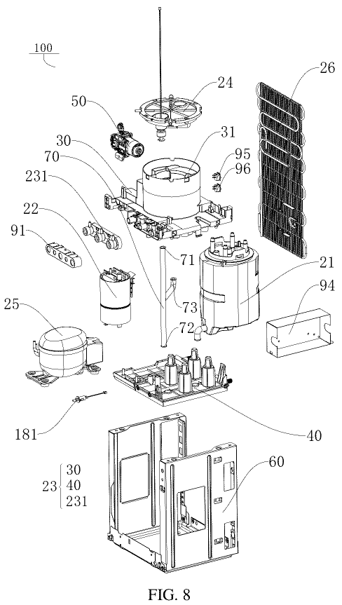

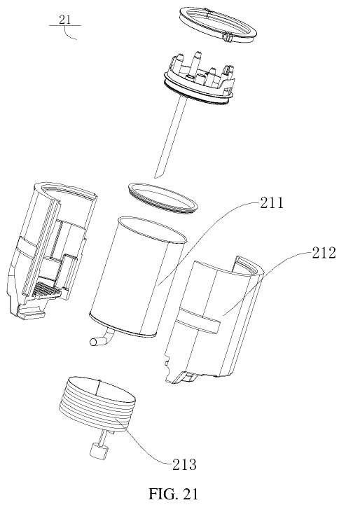

In some embodiments of the present disclosure, as shown in FIG. 7, FIG. 8, and FIG. 21, the plurality of water outlets 34 further include a third water outlet 343, and the water outlet passageway 33 further includes a third water outlet passageway 333. The water receiving basin 31 is in communication with the third water outlet 343 through the third water outlet passageway 333. In this way, the water in the water receiving basin 31 can flow out of the third water outlet 343 through the third water outlet passageway 333, to realize normal temperature water drainage of the bottom-loaded water dispenser 100 and satisfy requirements for required normal temperature water.

For example, in some specific embodiments, as shown in FIG. 22, when the bottom-loaded water dispenser 100 operates, the water in the water bucket 51 enters the water receiving basin 31, and a part of the water in the water receiving basin 31 may flow to the cooling tank assembly 21 through the first water inlet passageway 321 and be refrigerated by the cooling tank assembly 21 to provide cold water. A part of the water in the water receiving basin 31 may flow to the heating tank assembly 22 through the second water inlet passageway 322 and be heated through the heating tank assembly 22 to provide hot water. A part of the water in the water receiving basin 31 may be stored in the water receiving basin 31 to provide the normal temperature water. When a user needs the cold water, the cold water in the cooling tank assembly 21 flows out of the bottom-loaded water dispenser 100 through the first water outlet passageway 331 via the first water outlet 341, realizing water supply requirements of the bottom-loaded water dispenser 100 for the cold water. When the user needs the hot water, the hot water in the heating tank assembly 22 flows out of the bottom-loaded water dispenser 100 through the second water outlet passageway 332 via the second water outlet 342 to realize water supply requirements of the bottom-loaded water dispenser 100 for hot water. When the user needs the normal temperature water, the normal temperature water in the water receiving basin 31 flows out of the bottom-loaded water dispenser 100 through the third water outlet passageway 333 via the third water outlet 343, to realize water supply requirements of the bottom-loaded water dispenser 100 for the normal temperature water.

In some embodiments of the present disclosure, as shown in FIG. 9 and FIG. 22, the first manifold 30 further has a water supply passageway 36. The water supply passageway 36 being adapted to bring the water bucket 51 in communication with an inlet of the water pump 50. In this way, the water bucket 51 can supply water to the water pump 50 through the water supply passageway 36, and the required water supply requirements are achieved. By providing the water supply passageway 36 on the first manifold 30, it is convenient to realize a water supply function of the bottom-loaded water dispenser 100 through cooperation of the first manifold 30 and the water pump 50, which can improve the reliability and an integration degree of the water passageway assembly 23, can improve the assembly efficiency of the bottom-loaded water dispenser 100, and is beneficial to improve the production efficiency.

In some embodiments of the present disclosure, as shown in FIG. 9 and FIG. 22, the water supply passageway 36 is connected to the water bucket 51 through a water supply tube. The water supply passageway 36 is disposed in the first cavity 10a, and the water bucket 51 is disposed in the second cavity 10b. By providing the water supply tube, the water bucket 51 can supply water to the water supply passageway 36 through the water supply tube, with a simple structure, which can realize the required water supply requirements while facilitating the assembly and disassembly.

In some embodiments, the water supply passageway 36 is directly connected to the inlet of the water pump 50, and the water in the water supply passageway 36 may directly enter the water pump 50 to achieve the required water supply requirements, which can realize quick mounting and disassembly, improve the assembly efficiency, and facilitate maintenance and replacement.

In some embodiments of the present disclosure, as shown in FIG. 6 to FIG. 9, the water receiving basin 31 has an opening at an upper end of the water receiving basin 31. The functional module 20 further includes a cover plate 24 covering the opening of the water receiving basin 31 at the upper end of the water receiving basin 31, which has a simple structure and is convenient to assemble. The cover plate 24 may cooperate with the water receiving basin 31 to form a closed water storage space, to ensure airtightness of the water receiving basin 31 and a cleanliness degree of the water inside the water receiving basin 31. An outlet of the water pump 50 is connected to the cover plate 24 through a connection tube 241. The connection tube 241 has an end in communication with the water receiving basin 31 and another end in communication with the outlet of the water pump 50. In this way, the water pumped by the water pump 50 from the water bucket 51 can be supplied to the water receiving basin 31 through the connection tube 241, with the simple structure, which can realize the required water supply requirements.

In some embodiments of the present disclosure, as shown in FIG. 10, FIG. 11, and FIG. 22, the water inlet passageway 32 and the water outlet passageway 33 are located below the water receiving basin 31, which can prevent the water inlet passageway 32 and the water outlet passageway 33 from interfering with the water receiving basin 31, to ensure a compact structure, can reduce an occupied space, and can improve a structural strength of the first manifold 30, reducing a water leakage risk.

In some embodiments of the present disclosure, the first manifold 30 is an integrated piece, which is simple to manufacture and has a high connection strength, can improve sealing performance and stability of the first manifold 30 and reduce assembly processes, and can improve the production efficiency.

In some embodiments of the present disclosure, as shown in FIG. 10, FIG. 11, and FIG. 22, the first manifold 30 further has an exhaust passageway 35. The cooling tank assembly 21 and the heating tank assembly 22 are in communication with the exhaust passageway 35. The cooling tank assembly 21 and the heating tank assembly 22 may be in communication with the air through the exhaust passageway 35 to balance air pressures in the cooling tank assembly 21 and the heating tank assembly 22, to ensure that the water in the cooling tank assembly 21 and the water in the heating tank assembly 22 flow smoothly. In addition, an internal pressure of the heating tank assembly 22 is easy to increase during heating, and pressure relief may be performed on the heating tank assembly 22 through the exhaust passageway 35, to ensure operation stability of the water dispenser.

In some embodiments of the present disclosure, as shown in FIG. 10, FIG. 11, and FIG. 22, the exhaust passageway 35 includes a first air passageway 351 and a second air passageway 352. The cooling tank assembly 21 is in communication with the first air passageway 351, allowing the air in the cooling tank assembly 21 to flow out through the first air passageway 351. The heating tank assembly 22 is in communication with the second air passageway 352, allowing the air in the heating tank assembly 22 to flow out through the second air passageway 352. In this way, independent exhaust of the heating tank assembly 22 and the cooling tank assembly 21 is realized, to prevent the heating tank assembly 22 and the cooling tank assembly 21 from interfering with each other, ensuring smooth air flow and making it beneficial to improve exhaust efficiency.

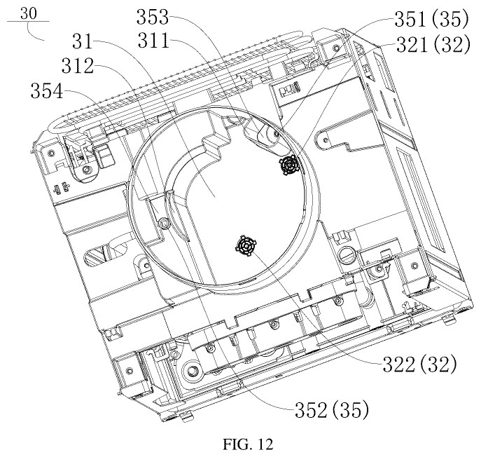

According to some embodiments of the present disclosure, as shown in FIG. 12, the water receiving basin 31 is internally provided with a first partitioning member 311 and a second partitioning member 312. The first partitioning member 311 may divide the water receiving basin 31 into a first exhaust region 353. The first air passageway 351 is in communication with the cooling tank assembly 21 and the first exhaust region 353, allowing the air in the cooling tank assembly 21 to flow out through the first air passageway 351 into the first exhaust region 353. Moreover, the first exhaust region 353 is divided by the first partitioning member 3110, which can reduce an effect of the air discharged from the cooling tank assembly 21 on a water temperature in the water receiving basin 31.

In some embodiments, the second partitioning member 312 may divide the water receiving basin 31 into a second exhaust region 354. The second air passageway 352 is in communication with the heating tank assembly 22 and the second exhaust region 354, allowing the air in the heating tank assembly 22 to flow out through the second air passageway 352 into the second exhaust region 354. Moreover, the second exhaust region 354 is divided by the second partitioning member 312. In this way, an effect of the air discharged from the heating tank assembly 22 on the water temperature in the water receiving basin 31 can be reduced. Meanwhile, compared with directly exhausting the air to an outside, exhausting the air into the water receiving basin 31 can effectively prevent an external environment from polluting an interior of each of the heating tank assembly 22 and the cooling tank assembly 21, ensuring cleanliness and hygiene, and can ensure that the bottom-loaded water dispenser 100 has a compact structure, which is beneficial to reduce the production costs.

In some embodiments, as shown in FIG. 12, a return flow channel is formed on the second partitioning member 312, and the second exhaust region 354 is in communication with the water receiving basin 31 through the return flow channel. When a high-temperature gas in the heating tank assembly 22 enters the second exhaust region 354 through the second air passageway 352, the high-temperature gas is cooled, and releases heat and is liquefied in the second exhaust region 354 to generate water in the second exhaust region 354, and the water in the second exhaust region 354 may enter the water receiving basin 31 through the return flow channel, which can avoid waste of water and prevent water from lingering in the second exhaust region 354 for a long time and generating sludge, making it beneficial to ensure a cleanliness degree of the water receiving basin 31.

In some embodiments of the present disclosure, as shown in FIG. 8 to FIG. 11, and FIG. 22, the water passageway assembly 23 further includes a second manifold 40 having a drainage passageway 41. The cooling tank assembly 21 and the heating tank assembly 22 are in communication with the drainage passageway 41. In this way, the water in the cooling tank assembly 21 and the water in the heating tank assembly 22 can flow out through the drainage passageway 41. It can be understood that when the bottom-loaded water dispenser 100 is not used for a long time, residual water in the cooling tank assembly 21 and residual water in the heating tank assembly 22 may be drained through the drainage passageway 41, to avoid contamination of the interior of the cooling tank assembly 21 and the interior of the heating tank assembly 22 by mud, scale, bacteria, and the like that are generated by prolonged water retention, control growth of microorganisms inside the cooling tank assembly 21 and the heating tank assembly 22, and maintain an overall hygienic condition of the functional module 20. In this way, fresh degrees and treatment efficiency of water qualities in the cooling tank assembly 21 and the heating tank assembly 22 can be maintained, and use safety of the bottom-loaded water dispenser 100 can be improved, making the user feel more relieved when using the water and enhancing the user's experience.

In addition, by integrating the drainage passageway 41 into the second manifold 40, it is convenient to realize a drainage function of the bottom-loaded water dispenser 100, and the reliability of the water passageway assembly 23 can be improved. Compared with the connection realized by the silicone tube in the related technology, the second manifold 40 in the present disclosure has a reliable connection and a high structural strength, which is beneficial to prolong its service life, can improve the assembly efficiency of the bottom-loaded water dispenser 100, and is beneficial to improve the production efficiency.

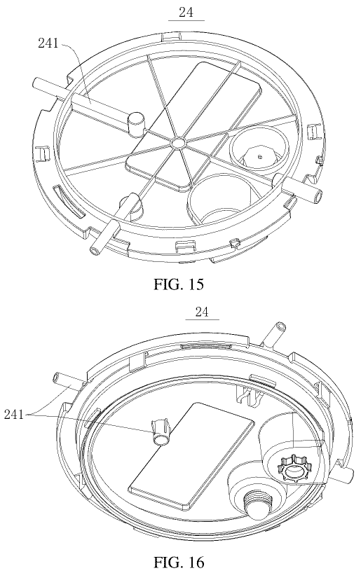

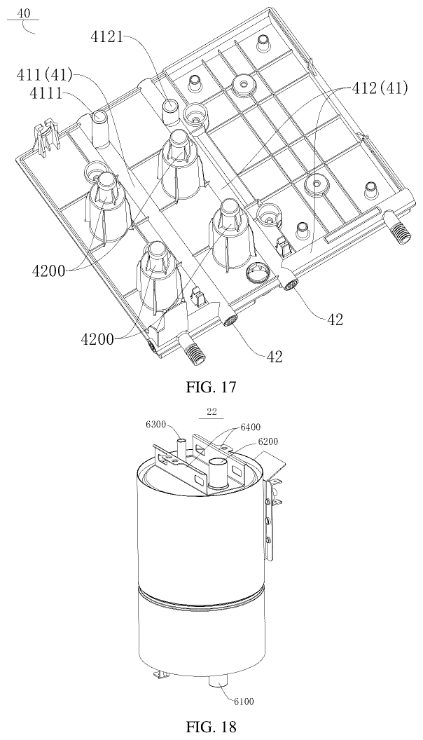

In some embodiments of the present disclosure, as shown in FIG. 10 to FIG. 12, FIG. 17, and FIG. 22, the drainage passageway 41 includes a first drainage passageway 411 and a second drainage passageway 412. The cooling tank assembly 21 is in communication with the first drainage passageway 411, and the heating tank assembly 22 is in communication with the second drainage passageway 412. When an outlet of the first drainage passageway 411 is opened, the residual water in the cooling tank assembly 21 may be drained from the outlet of the first drainage passageway 411 and flow out of the bottom-loaded water dispenser 100, to avoid the contamination of the interior of the cooling tank assembly 21 by mud, scale, bacteria, and the like that are generated by the prolonged water retention, control the growth of the microorganisms inside the cooling tank assembly 21, and maintain the overall sanitary conditions of the functional module 20. In this way, the fresh degree and the treatment efficiency of the water quality in the cooling tank assembly 21 can be maintained, and the use safety of the bottom-loaded water dispenser 100 can be improved, making the user feel more relieved when using the water and enhancing the user's experience. When an outlet of the second drainage passageway 412 is opened, the heating tank assembly 22 and the water receiving basin 31 share the second drainage passageway 412, and the residual water in the heating tank assembly 22 and the water receiving basin 31 may be drained, to avoid the contamination of the interior of the heating tank assembly 22 by mud, scale, bacteria, and the like that are generated by the prolonged water retention, control growth of microorganisms inside the heating tank assembly 22 and the water receiving basin 31, and maintain the overall sanitary conditions of the functional module 20. In this way, fresh degrees and treatment efficiency of water qualities in the heating tank assembly 22 and the water receiving basin 31 can be maintained, and the use safety of the bottom-loaded water dispenser 100 can be improved, making the user feel more relieved when using the water and enhancing the user's experience.

In some embodiments of the present disclosure, as shown in FIG. 10, FIG. 11, and FIG. 22, the first manifold 30 is located above the second manifold 40, and the cooling tank assembly 21 and the heating tank assembly 22 are located between the first manifold 30 and the second manifold 40. It is beneficial to reasonably utilize a space and ensure a compact structure. In addition, the cooling tank assembly 21 and the heating tank assembly 22 can be protected, to prevent external structures from damaging the cooling tank assembly 21 and the heating tank assembly 22 and ensure the use safety. It can be understood that the water may naturally flow from the first manifold 30 to the cooling tank assembly 21 or the heating tank assembly 22 by using a gravity of the water itself, and naturally flow from the cooling tank assembly 21 or the heating tank assembly 22 to the second manifold 40 without the need to be driven by an external force such as the water pump 50, which can relatively reduce a quantity of parts of the functional module 20, simplify the assembly process of the functional module 20, improve the assembly efficiency of the bottom-loaded water dispenser 100, and reduce the production cost of the bottom-loaded water dispenser 100.

In some embodiments of the present disclosure, as shown in FIG. 8, the bottom-loaded water dispenser 100 further includes a three-way tube 70 having a first port 71, a second port 72, and a third port 73. The first port 71 is in communication with the water inlet passageway 32. The second port 72 is in communication with the drainage passageway 41. The third port 73 is in communication with the heating tank assembly 22. The arrangement of the three-way tube 70 may realize communication of the water inlet passageway 32, the drainage passageway 41, and the heating tank assembly 22, allowing the water in the water inlet passageway 32 to flow into the heating tank assembly 22 through the first port 71 and the third port 73, the water in the water inlet passageway 32 to flow to the drainage passageway 41 through the first port 71 and the second port 72, and the water in the heating tank assembly 22 to flow to the drainage passageway 41 through the third port 73 and the second port 72, which can satisfy required communication requirements.

Meanwhile, the heating tank assembly 22 and the water inlet passageway 32 share the drainage passageway 41, which facilitates drainage of the water in the heating tank assembly 22 and the water receiving basin 31, and is beneficial to save a quantity of pipelines connected among the heating tank assembly 22, the first manifold 30, and the second manifold 40, reducing the quantity of parts of the functional module 20, simplifying the assembly process of the functional module 20, improving the assembly efficiency of the bottom-loaded water dispenser 100, and reducing the production cost of the bottom-loaded water dispenser 100.

According to some embodiments of the present disclosure, as shown in FIG. 17, the second manifold 40 further includes an openable member 42. The openable member 42 openably closes an end of the drainage passageway 41 away from the cooling tank assembly 21 or the heating tank assembly 22. Under the action of gravity, the drainage passageway 41 may be filled with water. When drainage is needed, the end of the drainage passageway 41 away from the cooling tank assembly 21 or the heating tank assembly 22 is exposed by the openable member, which can realize the drainage function required by the bottom-loaded water dispenser 100. When the drainage is not needed, the end of the drainage passageway 41 away from the cooling tank assembly 21 or the heating tank assembly 22 is covered by the openable member, to ensure normal use of the bottom-loaded water dispenser 100.

In some embodiments, the second manifold 40 is provided with a drainage connector cooperating with the openable member 42, and the drainage connector is threadedly connected to the openable member 42, which is convenient to realize the exposing and covering of the drainage passageway 41, and can avoid a water leakage problem of the bottom-loaded water dispenser 100 caused by opening the drainage passageway 41 when the openable member 42 is subjected to an external impact, to ensure the use safety.

In some embodiments, as shown in FIG. 21, the cooling tank assembly 21 includes a cooling tank 211, a heat preservation member 212, and a refrigeration member 213. The heat preservation member 212 covers at an outer peripheral side and a bottom of the cooling tank 211, which can play a good heat preservation and protection role for the cooling tank 211, allowing cold water in a water storage cavity of the cooling tank 211 to better keep its temperature stable. The heat preservation member 212 cooperates with the cooling tank 211 to define a mounting cavity. The refrigeration member 213 is disposed in the mounting cavity and is sleeved on an outer side of the cooling tank 211, which can perform efficient and stable cooling and a temperature reduction on the cold water in the water storage cavity of the cooling tank 211. The heat preservation member 212 may reduce an effect of an external environment temperature on a cooling effect of the refrigeration member 213, allowing for a better cooling effect of the refrigeration member 213 on the cooling tank 211 and making energy consumption of the refrigeration member 213 reduced to some extent.

In some embodiments, the cooling tank assembly 21 and the heating tank assembly 22 are engaged with the first manifold 30 through insertion to ensure that the cooling tank assembly 21 and the heating tank assembly 22 are reliably connected to the first manifold 30, ensuring airtightness between the cooling tank assembly 21 and the first manifold 30 and between the heating tank assembly 22 and the first manifold 30, and preventing the occurrence of the water leakage problem. In addition, it is possible to realize rapid mounting and disassembly, improve the assembly efficiency, and facilitate the maintenance and replacement.

In some embodiments, the cooling tank assembly 21 and the heating tank assembly 22 are engaged with the second manifold 40 through insertion to ensure that the cooling tank assembly 21 and the heating tank assembly 22 are reliably connected to the second manifold 40, ensuring airtightness between the cooling tank assembly 21 and the second manifold 40 and between the heating tank assembly 22 and the second manifold 40, and preventing the occurrence of the water leakage problem. In addition, it is possible to realize the rapid mounting and disassembly, improve the assembly efficiency, and facilitate the maintenance and replacement.

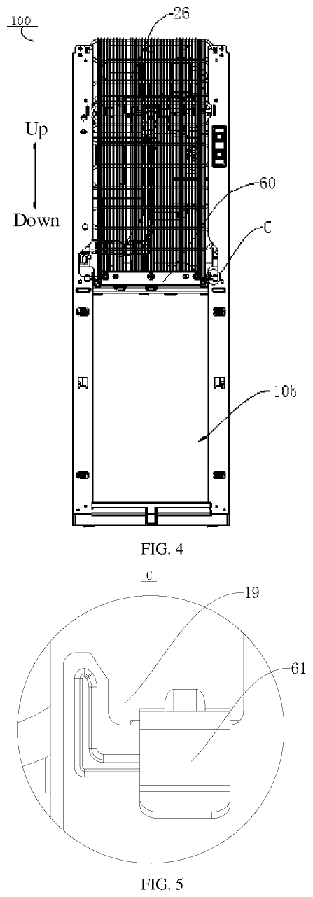

According to some embodiments of the present disclosure, as shown in FIG. 4 and FIG. 5, the support 60 is in a snap-fit connection with the housing 10 to ensure that the support 60 is reliably fixed on the housing 10. In this way, it is ensured that the functional module 20 is reliably fixed in the housing 10, which avoids problems such as shaking of the functional module 20 in the housing 10 and facilitates assembly. In this way, it is beneficial to improve the assembly efficiency.

According to some embodiments of the present disclosure, as shown in FIG. 4 and FIG. 5, the support 60 is provided with a hook 61, the housing 10 has a hook slot 19 formed thereon, and the hook 61 cooperates with the hook slot 19. Therefore, by cooperating the hook 61 with the hook slot 19, it can be ensured that the support 60 is fixed on the housing 10, and pre-position can be achieved. In addition, quick positioning and mounting of the support 60 and the housing 10 can be ensured, which is beneficial to improve the assembly efficiency.

In some embodiments, as shown in FIG. 4 and FIG. 5, a plurality of hooks 61 may be provided. The plurality of hooks 61 are arranged at intervals on the support 60. A plurality of hook slots 19 may be provided. The plurality of hook slots 19 cooperate with the plurality of hooks 61. In this way, guiding and positioning of the support 60 and the housing 10 at different positions can be realized through cooperation of the hook slots 19 and the hooks 61 at different positions in one-to-one correspondence, further improving assembly accuracy of the support 60 and the housing 10, which is beneficial to improve the assembly efficiency.

In the embodiment of the present disclosure, a quantity of hooks 61 may be flexibly set as actual situations. For example, as shown in FIG. 4 and FIG. 5, four hooks 61 may be provided, and two hooks 61 are provided at each of two opposite sides of the support 60, which can ensure that the two opposite sides of the support 60 are reliably fixed on the housing 10, avoiding the problems such as shaking. In addition, the quantity of hooks 61 may be two, three, five, six, or more, which are all within the protection scope of the present disclosure.

According to some embodiments of the present disclosure, the support 60 is connected to the housing 10 by a fastener, to ensure that the support 60 is reliably connected to the housing 10, allowing the support 60 to be reliably fixed on the housing 10. In this way, it is ensured that the functional module 20 is reliably fixed on the housing 10, the disassembly is facilitated, facilitating the maintenance or replacement. Therefore, the production costs can be reduced. For example, the fastener may be a screw or the like.

In some embodiments, there may be a plurality of fasteners (two or more fasteners). Fixing of the support 60 and the housing 10 at a plurality of different positions may be realized through the plurality of fasteners, to ensure that the support 60 is reliably fixed to the housing 10.

For example, in some embodiments, two opposite sides of the housing 10 are each connected to two opposite sides of the support 60 by four fasteners, and the four fasteners are arranged at intervals. The eight fasteners may ensure that the support 60 is reliably connected to the housing 10, and the support 60 is prevented from shaking on the housing 10, ensuring that the functional module 20 is reliably fixed in the housing 10.

In some embodiments of the present disclosure, as shown in FIG. 2, the housing 10 has a through hole 11 formed at a front side of the housing 10. The bottom-loaded water dispenser 100 further includes a water outlet member 80. The water outlet member 80 is adapted to pass through the through hole 11, detachably connect to the water passageway assembly 23, and be in communication with the water outlet 34. The water outlet member 80 is provided with a switch that may be used for controlling whether the water flows out of the water outlet member 80. When the water is needed to be received, the water outlet member 80 may be opened, allowing the water in the water passageway assembly 23 to flow out of the water outlet member 80 via the water outlet 34. When the water receiving is finished, the water outlet member 80 may be closed to prevent the water from flowing out of the water outlet member 80, which is simple to operate and convenient for the user to receive water. For example, the water outlet member 80 may be a faucet. The water outlet member 80 is detachably connected to the water passageway assembly 23, which can facilitate maintenance and replacement of the water outlet member 80 when water leakage or other problems occur in the water outlet member 80, and can reduce a maintenance difficulty of the bottom-loaded water dispenser 100 and shorten a maintenance time of the

In an exemplary embodiment of the present disclosure, as shown in FIG. 6 to FIG. 8, the water passageway assembly 23 further includes a water outlet manifold 231. The water outlet manifold 231 includes a water outlet connector 92 and a water outlet fixing cover 91. The water outlet connector 92 is configured to bring an inlet of the water outlet member 80 in communication with the water outlet 34 of the first manifold 30. The water in the water outlet passageway 33 may flow into the water outlet connector 92 from the water outlet 34 of the first manifold 30, then flows into the water outlet member 80 from the inlet of the water outlet member 80, and finally flows out of the bottom-loaded water dispenser 100 from an outlet of the water outlet member 80, to satisfy user's water receiving requirements. The water outlet connector 92 includes a cold water faucet 921, a hot water faucet 922, and a normal temperature water faucet 923. The cold water faucet 921 is in communication with the first water outlet 341. The hot water faucet 922 is in communication with the second water outlet 342. The normal temperature water faucet 923 is in communication with the third water outlet 343.

In some embodiments, as shown in FIG. 6 to FIG. 8, the water outlet fixing cover 91 is disposed at a side of the water outlet connector 92 facing towards the water outlet member 80. The water outlet fixing cover 91 defines a mounting space and is opened towards a side of the first manifold 30. The water outlet connector 92 is at least partially located in the mounting space. The arrangement of the water outlet fixing cover 91 may play a fixing and protection role for the water outlet connector 92, ensuring that the water outlet connector 92 is opposite to the inlet of the water outlet member 80.

In some embodiments, as shown in FIG. 6 to FIG. 8, the inlet end of the water outlet member 80 passes through the through hole 11 and sequentially penetrates the front housing 16 and the water outlet fixing cover 91, and is detachably connected to the water outlet connector 92, which can facilitate the maintenance and replacement of the water outlet member 80 when the water leakage or other problems occur in the water outlet member 80, reduce the maintenance difficulty of the bottom-loaded water dispenser 100, and shorten the maintenance time of the

In some embodiments of the present disclosure, referring to FIG. 2, the bottom-loaded water dispenser 100 further includes a water collection box 81. The water collection box 81 is disposed at the front side of the housing 10 and located below the water outlet member 80, and the water outlet member 80 has an outlet. It can be understood that during water receiving by using the bottom-loaded water dispenser 100, in response to a water cup being not aligned with the outlet of the water outlet member 80, the water flowing out of the outlet may flow into the water collection box 81. Alternatively, when the water cup is already full of water, and when the user does not notice it in time, any overflow of the water from the water cup may also flow into the water collection box 81. The arrangement of the water collection box 81 allows for temporary water storage, to prevent the water flowing out of the outlet of the water outlet member 80 from spilling onto the ground, avoiding occurrence of ground slippery, pedestrian slipping, and other situations.

In some embodiments, as shown in FIG. 1, a distance between the outlet and the water collection box 81 in an up-down direction is d and satisfies: 27 mm≤d≤233 mm. It can be understood that the user often has a habit of placing the water cup on the water collection box 81 when receiving water with the water cup. However, in the prior art, the distance between the water collection box and the outlet generally ranges from 150 mm to 190 mm. When the user uses a high water cup with a height greater than 200 mm, the user is unable to place the high water cup on the water collection box. Therefore, the user needs to hold the high water cup to receive water, which diminishes the user's usage experience.

In the present disclosure, the distance d between the outlet and the water collection box 81 satisfies 227 mm≤d≤233 mm, which can increase the distance d between the outlet and the water collection box 81. In this way, when the user uses the bottom-loaded water dispenser 100, whether the user is using a lower water cup or a higher one, the water cup can be better placed on the water collection box 81 without interference from the water outlet member 80, which can better free user's hands, enhancing the user's experience and comfort. For example, the distance d between the outlet and the water collection box 81 may be 227 mm, 229 mm, 230 mm, 231 mm, or 233 mm.

In the embodiment of the present disclosure, specific structures of the water outlet member 80 and the water collection box 81 may be set as the actual situations. For example, the functional module 20 may be formed as the basic definition platform, which can expand the water outlet member 80 and the water collecting box 81 in shape and color, can realize the production of bottom-loaded water dispensers 100 with different appearances, facilitates a design of the bottom-loaded water dispenser 100 with a new appearance, is beneficial to reduce design costs, and can lead to a reduction in labor hours and manufacturing costs.

For example, in some embodiments, as shown in FIG. 3, when the housing 10 and the functional module 20 are assembled, the first side plate 14 is connected to the second side plate 15 by the bottom plate 12. A relative position relationship between the first side plate 14 and the second side plate 15 may be maintained by the bottom plate 12, which can improve structural stability of the housing 10. The functional module 20 is placed into the housing 10 through upper ends of the first side plate 14 and the second side plate 15. A distance between the upper ends of the first side plate 14 and the second side plate 15 becomes larger, making the first side plate 14 and the second side plate 15 in an assembled state. In this way, an installation channel for the functional module 20 that gradually widens from bottom to top can be formed. Therefore, it is possible to reduce a difficulty of placing the functional module 20 between the first side plate 14 and the second side plate 15 from top to bottom, and it is beneficial to improve assembly efficiency of the functional module 20 and the housing 10. Further, after assembly of the housing 10 and the functional module 20 is completed, the functional module 20 is placed in the housing 10 and connected to the housing 10, and a distance between the first side plate 14 and the second side plate 15 is unchanged in the up-down direction. In this way, it is ensured that the first side plate 14 and the second side plate 15 are reliably fixed to the functional module 20.

It needs to be noted that the relative position relationship between the first side plate 14 and the second side plate 15 in the assembled state may be realized by a swing mechanism. For example, lower ends of the first side plate 14 and the second side plate 15 are connected to the bottom plate 12 by their corresponding swing mechanisms, respectively. The first side plate 14 is swingable relative to the bottom plate 12 in a direction away from the second side plate 15 by the corresponding swing mechanism, and the second side plate 15 is swingable relative to the bottom plate 12 in a direction away from the first side plate 14 by the corresponding swing mechanism, to ensure that the distance between the first side plate 14 and the second side plate 15 gradually increases from bottom to top in the assembled state. Alternatively, the relative position relationship of the first side plate 14 and the second side plate 15 in the assembled state may be directly realized by applying a pushing force to the upper ends of the first side plate 14 and the second side plate 15 and pushing the first side plate 14 and the second side plate 15 away from each other, making a slight deformation of the first side plate 14 and the second side plate 15. A manner where the first side plate 14 and the second side plate 15 are switched to the assembled state is not specifically limited here.

In some embodiments, in the assembled state, an angle between the first side plate 14 and the up-down direction and an angle between the second side plate 15 and the up-down direction range from 10° to 20°. Therefore, an inclination angle of the first side plate 14 in the assembled state relative to the up-down direction and an inclination angle of the second side plate 15 in the assembled state relative to the up-down direction can satisfy required assembly requirements, facilitate placement of the functional module 20 into the housing 10, and avoid occurrence of problems such as deformation or swing of the first side plate 14 and the second side plate 15. For example, in some specific embodiments, in the assembled state, the angle between the first side plate 14 and the up-down direction and the angle between the second side plate 15 and the up-down direction may be 10°, 11°, 12°, 13°, 14°, 15°, 16°, 17°, 18°, 19°, or 20°.

In some embodiments, as shown in FIG. 2, the bottom-loaded water dispenser 100 further includes a display assembly 93, and the display assembly 93 is disposed in the housing 10. The display assembly 93 may be protected by the housing 10, to avoid damage caused by exposure of the display assembly 93. In addition, the display assembly 93 may be used for displaying an operation state of the bottom-loaded water dispenser 100, such as displaying heating, cooling, and other information of the bottom-loaded water dispenser 100.

In some embodiments, as shown in FIG. 6 to FIG. 11, the functional module 20 includes a compressor 25 and a condenser 26. The compressor 25 is in communication with the condenser 26. The compressor 25 may compress a refrigerant to drive a refrigeration cycle, to realize refrigeration requirements of the water dispenser for the water. Moreover, the condenser 26 may dissipate heat from the refrigerant and cool the refrigerant, to realize circulation and flow of the refrigerant between the compressor 25 and the condenser 26, and ensure a good refrigeration effect.

In some embodiments, as shown in FIG. 6 to FIG. 8, the bottom-loaded water dispenser 100 further includes an electronic control system, and the electronic control system is disposed in an electronic control box 94. The heating tank assembly 22 and the cooling tank assembly 21 may be controlled by the electronic control system, to realize control requirements of the heating tank assembly 22 and the cooling tank assembly 21.

Further, as shown in FIG. 8, the functional module 20 includes a first switch 95 and a second switch 96. When the first switch 95 is turned on, a heating circuit may be on to start heating, realizing the heating requirements of the heating tank assembly 22. When the first switch 95 is turned off, the circuit may be off, allowing the heating to be stopped. When the second switch 96 is turned on, a refrigeration circuit may be on, to start refrigerating to fulfill the heating requirements of the cooling tank assembly 21. When the second switch 96 is turned off, the circuit may be off to stop refrigerating. Therefore, a heating function and a cooling function of the bottom-loaded water dispenser 100 can be realized by controlling the first switch 95 and the second switch 96, and different operation modes of the bottom-loaded water dispenser 100 can be easily realized by the user's operation. For example, the first switch 95 and the second switch 96 may be rocker switches.

In some specific examples of the present disclosure, the functional module 20 may be provided with a wire buckle, and the wire buckle is used for at least partially positioning a wiring harness in the bottom-loaded water dispenser 100, to ensure regularity of the wiring harness, reducing a safety risk of the bottom-loaded water dispenser 100.

In some specific examples of the present disclosure, a water source interface inside the water receiving basin 31 is mounted with a small piece of filtration mesh to prevent foreign matters from jamming the water source interface, while preventing bottled-water foreign matters from flowing into user's body, to ensure hygiene and safety of drinking water.

As illustrated in FIG. 1 to FIG. 8, in some embodiments, the bottom-loaded water dispenser includes the functional module 20 and the second cavity 10b. The second cavity 10b is disposed below the functional module 20 and is used for receiving the water bucket. The functional module 20 includes a first manifold 30, a second manifold 40, the water pump 50, the cooling tank assembly 21, and the heating tank assembly 22. The first manifold 30 has the water outlet passageway 33, the water inlet passageway 32, and the water receiving basin 31. The second manifold 40 has a drainage passageway 41. The water pump 50 is used for pumping water from the water receiving basin 31. The cooling tank assembly 21 is used for being in communication with the water inlet passageway 32, the water outlet passageway 33, and the drainage passageway 4100. In this way, the water from the water receiving basin 3100 can be received through the water inlet passageway 32, the refrigerated water can be outputted through the water outlet passageway 33, and the water in the cooling tank assembly 21 can be drained through the drainage passageway 4100. The heating tank assembly 22 is used for being in communication with the water inlet passageway 32, the water outlet passageway 33, and the drainage passageway 4100. In this way, the water from the water receiving basin 3100 can be received through the water inlet passageway 32, the heated water can be outputted through the water outlet passageway 33, and the water in the heating tank assembly 22 can be drained through the drainage passageway 4100.

The first manifold 30 and the second manifold 40 may be used as core components to be connected to the cooling tank assembly 21 and the heating tank assembly 22, realizing passageway communication. The first manifold 30 and the second manifold 40 are provided with corresponding passageways, which replaces at least a part of silicone tubes in a traditional bottom-loaded water dispenser, reduces use of the silicone tube, effectively avoids the occurrence of the water leakage problem, is more conducive to module and assembly, and improves the production efficiency.

In an exemplary embodiment of the present disclosure, the first manifold 30 has the water receiving basin 31, the water inlet passageway 32, and the water outlet passageway 33. The water receiving basin 31 is a component for temporarily storing a predetermined amount of water, and water supply of the water receiving basin 31 needs to be realized by the water pump 50. The water pump 50 pumps the water in the water bucket to the water receiving basin 31. Since the water bucket is placed in the second cavity 10b, and the second cavity 10b is located below the functional module 20, the water pump 50 pumps the water in the water bucket from bottom to up to the water receiving basin 31, without the need for the user to lift the water bucket to a higher height. The bottom-loaded water dispenser includes the door body 18, and the door body 18 may expose and cover the second cavity 10b. The door body 18 is controlled to expose the second cavity 10b when the water bucket needs to be replaced and to cover the second cavity 10b when the water bucket is replaced. The door body 18 may be provided to form protection of the water bucket and prevent the water bucket from being polluted.

The cooling tank assembly 21 is in communication with the water inlet passageway 32 and the water outlet passageway 33, and is used for refrigerating water entering the cooling tank assembly 21, which may be referred to the related technology. When the bottom-loaded water dispenser needs to output the cold water for the user to drink, the first water outlet 341 is turned on, the water in the water receiving basin 31 flows into the cooling tank assembly 21 through the water inlet passageway 32 and is cooled into the cold water, and the cold water flows to the first water outlet 341 through the water outlet passageway 33 and finally flows out of the first water outlet 341. The cooling tank assembly 21 is in communication with the drainage passageway 41. When it is necessary to clean the cooling tank assembly 21 and passageways in communication with the cooling tank assembly 21 (the passageways and a passage through which water is supplied and flows, including the water inlet passageway 32, the water outlet passageway 33, and/or the drainage passageway 41), the water in the cooling tank assembly 21 may be drained from the cooling tank assembly 21 and drained to the outside through the drainage passageway 41. For example, the drainage passageway 41 is provided with a corresponding valve or a soft plug. The water in the cooling tank assembly 21 may be drained to the outside through the drainage passageway 41 by opening the valve or the soft plug. When the valve or the soft plug is in a closed state, the water in the cooling tank assembly 21 may not be drained to the outside through the drainage passageway 41.

The heating tank assembly 6000 is in communication with the water inlet passageway 32 and the water outlet passageway 33, and is used for heating water entering the heating tank assembly 22, which may be referred to the related technology. When the bottom-loaded water dispenser needs to output the hot water for the user to drink, the second water outlet 342 is turned on, the water in the water receiving basin 31 flows into the heating tank assembly 22 through the water inlet passageway 32 and is heated into the hot water, and the hot water flows to the second water outlet 342 through the water outlet passageway 33 and finally flow out of the second water outlet 342. The heating tank assembly 22 is in communication with the drainage passageway 41. When it is necessary to clean the heating tank assembly 22 and a passageways in communication with the heating tank assembly 22, the water in the heating tank assembly 22 may be drained from the heating tank assembly 22 and drained to the outside through the drainage passageway 41.

It can be understood that the cooling tank assembly 21 and the heating tank assembly 22 may share the water inlet passageway 32, the water outlet passageway 33, and/or the drainage passageway 41, or may not share the water inlet passageway 32, the water outlet passageway 33, and/or the drainage passageway 41.

The so-called manifold is a component integrated with corresponding passageways. The first manifold 30 is integrated with the water inlet passageway 32 and the water outlet passageway 33. Functions of the water inlet passageway 32 and the water outlet passageway 33 are equivalent to the silicone tube in the traditional bottom-loaded water dispenser. Since the water inlet passageway 32 and the water outlet passageway 33 are integrated on the first manifold 30, the first manifold 30 has a structural strength much greater than a structural strength of a single silicone tube and is not easy to fracture. Therefore, a problem of fracture and water leakage is effectively avoided. Similarly, for the second manifold 40, the drainage passageway 41 is integrated on the second manifold 40 and is also equivalent to the silicone tube in the traditional bottom-loaded water dispenser. Since the drainage passageway 41 is integrated on the second manifold 40, the second manifold 40 has a structural strength much greater than the structural strength of the single silicone tube and is not easy to fracture. Therefore, the problem of fracture and water leakage is effectively avoided.

For example, the first manifold 30 and the second manifold 40 may be made of hard materials (hard meaning they are not easy to deform, such as by hand), which not only makes the corresponding passageways less likely to fracture and leak water, but also plays a predetermined supporting role in the installation of the cooling tank assembly 21 and the installation of the heating tank assembly 6000. It is worth noting that the water in the water receiving basin 31 is at a normal temperature, and feeding water of the cooling tank assembly 21 and feeding water of the heating tank assembly 22 come from the water receiving basin 31. In this way, a problem of water cross-contamination between the cooling tank assembly 21 and the heating tank assembly 22 can be avoided, and thus it is beneficial to reduce cooling energy consumption and heating energy consumption.

During assembly, the heating tank assembly 22 is assembled with the first manifold 30 and the second manifold 40, and the cooling tank assembly 21 is assembled with the first manifold 30 and the second manifold 40. Since the first manifold 30 and the second manifold 40 are respectively integrated with the corresponding passageways, communication between the corresponding passageways may be realized only by assembling the cooling tank assembly 21 with the first manifold 30 and the second manifold 40 and by assembling the heating tank assembly 22 with the first manifold 30 and the second manifold 40, eliminating the need for workers to connect the silicone tubes one by one as in the related technology. The first manifold 30 and the second manifold 3000 are highly integrated components, which more facilitates realization of automated production in factories and is beneficial to improve the production efficiency.

As shown in FIG. 6, FIG. 7, and FIG. 8, in some embodiments, the functional module 20 further includes a cover plate 24 covering the water receiving basin 31. The cover plate 24 is provided to form shielding of the water receiving basin 31 and play a role of blocking dust. In particular, since the predetermined amount of water is stored in the water receiving basin 31, the cover plate 24 also serves to block water when the bottom-loaded water dispenser is inclined to some extent under the action of the cover plate 24, to prevent the water from overflowing out of the water receiving basin 31.

As shown in FIG. 7, FIG. 15, and FIG. 16, the cover plate 24 is provided with a connection tube 241. The connection tube 241 may be a separate component fixedly connected to the cover plate 24 by a connection means or integrally formed and manufactured with the cover plate 24. The connection tube 241 has an end in communication with the water receiving basin 31 and another end in communication with the outlet of the water pump 50. The water pumped by the water pump 50 may enter the water receiving basin 31 through the connection tube 241. Since the connection tube 241 is disposed on the cover plate 24 without easily occurring a position change, the connection and communication between the water pump 50 and the connection tube 241 are facilitated. Moreover, the position change of the connection tube 241 is also not easy to occur relative to the water receiving basin 31 during transportation of the bottom-loaded water dispenser, to ensure the communication between the connection tube 241 and the water receiving basin 31.

For example, the connection tube 241 is fixed on the cover plate 24, and the outlet of the water pump 50 is connected to the connection tube 241 by a first water delivery hose 1100. The first water delivery hose 1100 is relatively soft and adapts to an arrangement of relative positions between the water pump 50 and the connection tube 241. In this way, communication between the outlet of the water pump 50 and the connection tube 241 is realized. Correspondingly, the water pump 50 may also be provided with a second water delivery hose 1200 connected to the inlet of the water pump 50, the second water delivery hose 1200 is connected to the first manifold 30, and the first manifold 30 is provided with a water supply tube (not shown) connected to the first manifold 30, and the water supply tube is in communication with the second water delivery hose 1200. That is, the first manifold 30 has a passageway (integrated on the first manifold 30), and the water supply tube is in communication with the second water delivery hose 1200 through the passageway. The water supply tube is adapted to extend into the water bucket, allowing the water pump 50 to realize suction of water in the water bucket.

In some embodiments, the functional module 20 further includes a water level gauge (not shown). It can be understood that the water level gauge is a component for detecting a water level. The water level gauge may trigger a signal when the water level reaches a predetermined value. For example, when the water level reaches the predetermined value, the water level gauge triggers the signal, allowing the water pump 50 to stop operating, to prevent the water pump 50 from pumping too much water to the water receiving basin 31. The water level gauge is disposed on the cover plate 24, and may be removed and mounted along with the cover plate 24. When the cover plate 24 covers the water receiving basin 31, the water level gauge is disposed in the water receiving basin 31. Since the water level gauge needs to measure a predetermined water level, the water level gauge needs to be located at an upper position of the water receiving basin 31. When the water level gauge is disposed on the cover plate 24, the water level gauge may be located at the upper position of the water receiving basin 31.

In some embodiments, the functional module 20 is entirely mounted in the housing 10 (the housing 10 is an external structure of the bottom-loaded water dispenser, and the housing 10 forms a shield and protection for the internal components of the bottom-loaded water dispenser), i.e., the functional module 20 may be separately assembled and is entirely mounted in the housing 10. In this way, module assembly is formed, which is beneficial to improve the production efficiency. In particular, the functional module 20 is designed to be entirely detachable relative to the housing 10. The functional module 20 may be entirely disassembled in an after-sales maintenance stage, without the need to disassemble different parts one by one relative to the housing 10, improving maintenance convenience.

For example, the functional module 20 further includes the support 60, the compressor 25, the condenser 26, and the electronic control system. The compressor 25, the cooling tank assembly 21, and the condenser 26 constitute a refrigerant circulation, realizing the refrigeration of the cooling tank assembly 21. The electronic control system controls operation of electricity-related components. The first manifold 30, the second manifold 40, the compressor 25, the condenser 26, the cooling tank assembly 21, the heating tank assembly 22, and the electronic control system are mounted on the support 60, i.e., the support 60 realizes supporting for the rest of components of the functional module 20, and the functional module 20 may be mounted to the housing 10 through the support 60.

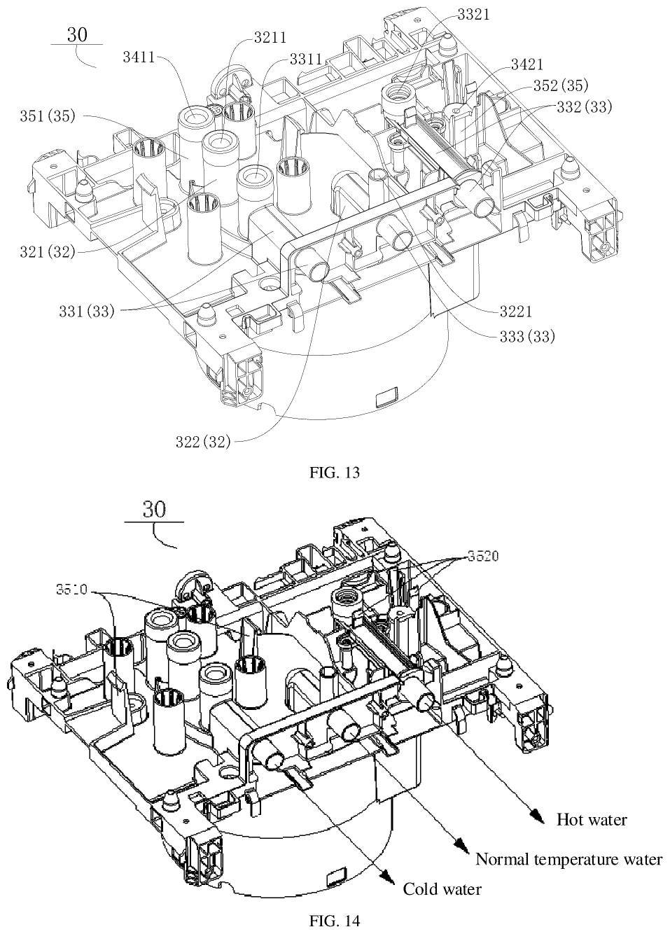

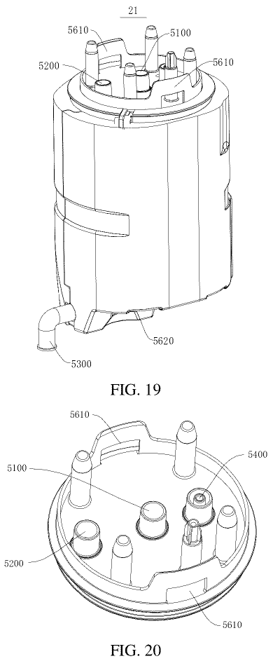

As shown in FIG. 12, FIG. 13, FIG. 17, FIG. 19, and FIG. 20, in some embodiments, the water inlet passageway 32 includes a first water inlet passageway 321 and a second water inlet passageway 322. The cooling tank assembly 21 is in communication with the first water inlet passageway 321. The heating tank assembly 22 is in communication with the second water inlet passageway 322. The water outlet passageway 33 includes a first water outlet passageway 331 and a second water outlet passageway 332. The cooling tank assembly 21 is in communication with the first water outlet passageway 331. The heating tank assembly 22 is in communication with the second water outlet passageway 332. Since the cooling tank assembly 21 and the heating tank assembly 22 respectively occupy a predetermined space, by providing the first water inlet passageway 321, the second water inlet passageway 322, the first water outlet passageway 331, and the second water outlet passageway 332, the cooling tank assembly 21 and the heating tank assembly 22 may be made more flexible in spatial arrangement.

In an exemplary embodiment of the present disclosure, the first water inlet passageway 321, the second water inlet passageway 322, the first water outlet passageway 331, and the second water outlet passageway 332 are spaced apart from each other on the first manifold 30. The first water inlet passageway 321 is in communication with the water receiving basin 31. The second water inlet passageway 322 is in communication with the water receiving basin 31. The cooling tank assembly 21 is in communication with the first water inlet passageway 321 and the first water outlet passageway 331. The heating tank assembly 22 is in communication with the second water inlet passageway 322 and the second water outlet passageway 332. The first water outlet passageway 331 is connected to the first water outlet 341, and the second water outlet passageway 332 is connected to the second water outlet 342.

When the bottom-loaded water dispenser needs to output the cold water for the user to drink, the first water outlet 341 is turned on, the water in the water receiving basin 31 flows into the cooling tank assembly 21 through the first water inlet passageway 321 to be cooled into the cold water, and the cold water flows to the first water outlet 341 through the first water outlet passageway 331 and finally flows out of the first water outlet 341. When the bottom-loaded water dispenser needs to output the hot water for the user to drink, the second water outlet 342 is turned on, the water in the water receiving basin 31 flows into the heating tank assembly 22 through the second water inlet passageway 322 to be heated into the hot water, and the hot water flows to the second water outlet 342 through the second water outlet passageway 332 and finally flows out of the second water outlet 342.

Similarly, the drainage passageway 41 includes the first drainage passageway 411 and the second drainage passageway 412. The first drainage passageway 411 is arranged corresponding to the cooling tank assembly 21 and in communication with the cooling tank assembly 21. The second drainage passageway 412 is arranged corresponding to the heating tank assembly 22 and in communication with the heating tank assembly 22. By providing the first drainage passageway 411 and the second drainage passageway 412, the drainage of the cooling tank assembly 21 and the drainage of the heating tank assembly 22 may be controlled, respectively. The water of the cooling tank assembly 21 is drained to the outside through the first drainage passageway 411, realizing cleaning. The water of the heating tank assembly 22 is drained to the outside through the second drainage passageway 412, realizing the cleaning. The drainage of the cooling tank assembly 21 and the drainage of the heating tank assembly 22 do not interfere with each other.

Further, in some embodiments, the cooling tank assembly 21 is connected to the first manifold 30 and the second manifold 40 in an insertion manner, allowing the cooling tank assembly 21 to be in communication with the first water inlet passageway 321, the first water outlet passageway 331, and the first drainage passageway 411. Assembly convenience is improved in the insertion manner.

In an exemplary embodiment of the present disclosure, as shown in FIG. 13, FIG. 17, FIG. 19, and FIG. 20, the cooling tank assembly 21 is provided with a cooling-tank drainage connector 5300, a cooling-tank water outlet connector 5200, and a cooling-tank water inlet connector 5100. The cooling-tank drainage connector 5300 is located at a bottom of the cooling tank assembly 21. The cooling-tank water outlet connector 5200 and the cooling-tank water inlet connector 5100 are located at a top of the cooling tank assembly 21. The cooling-tank drainage connector 5300, the cooling-tank water outlet connector 5200, and the cooling-tank water inlet connector 5100 are in communication with an internal space of the cooling tank assembly 21, respectively. The first water inlet passageway 321 is provided with a first water inlet connector 3211 at an end of the first water inlet passageway 321 and has another end in communication with the water receiving basin 31. The first water outlet passageway 331 is provided with a first water outlet connector 3311 at an end of the first water outlet passageway 331 and has another end connected to the first water outlet 341. The first drainage passageway 411 is provided with a first drainage connector 4111 at an end of the first drainage passageway 411 and has another end in communication with the outside. Since the cold water sinks, the cooling-tank water inlet connector 5100 is connected with a cold water pipe extending to the bottom of the cooling tank assembly 21.

When the functional module 20 is assembled, the first water inlet connector 3211 is connected to the cooling-tank water inlet connector 5100 in an insertion manner to be in communication with the cooling-tank water inlet connector 5100, allowing the water to flow from the first water inlet passageway 321 into the cooling tank assembly 21. The first water outlet connector 3311 is connected to the cooling-tank water outlet connector 5200 in an insertion manner to be in communication with the cooling-tank water outlet connector 5200, allowing the cold water to flow from the cooling tank assembly 21 to the first water outlet 341. The first drainage connector 4111 is connected to the cooling-tank drainage connector 5300 in an insertion manner to be in communication with the cooling-tank drainage connector 5300, allowing the water to flow from the cooling tank assembly 21 to the outside. It can be understood that being connected in the insertion manner means that one of the components is inserted into another component. As an example, the first water inlet connector 3211 is connected to the cooling-tank water inlet connector 5100 in the insertion manner. The first water inlet connector 3211 may be inserted into the cooling-tank water inlet connector 5100, or the cooling-tank water inlet connector 5100 may be inserted into the first water inlet connector 3211. The same principle applies to other similar connections.

As illustrated in FIG. 6 and FIG. 8, in some embodiments, the functional module 20 includes a three-way tube 70 having three end portions, i.e., the first port 71, the second port 72, and the third port 73, respectively. The first port 71 is in communication with the second water inlet passageway 322. The second port 72 is in communication with the second drainage passageway 412. The third port 73 is in communication with the heating tank assembly 22. For example, the three-way tube 70 is made of a hard material.

When the bottom-loaded water dispenser needs to output the hot water for the user to drink, the second water outlet 342 is turned on, and the water in the water receiving basin 31 flows into the three-way tube 70 (flows into the three-way tube 70 from the first port 71) through the second water inlet passageway 322, and flows out of the third port 73 to enter the heating tank assembly 22 to be heated into the hot water (the second drainage passageway 412 is in the closed state). The hot water flows through the second water outlet passageway 332 to the second water outlet 342 and finally flows out of the second water outlet 342. When it is necessary to clean the heating tank assembly 22 and the passageways in communication with the heating tank assembly 22, the water in the heating tank assembly 22 may be drained from the heating tank assembly 22, flows into the three-way tube 70 (flows into the three-way tube 70 from the third port 73), then flows out of the second port 72 to enter the second drainage passageway 412, and is drained to the outside through the second drainage passageway 412.

Since the hot water floats up in the heating tank assembly 22, the third port 73 is connected to a bottom of the heating tank assembly 22. The water entering the heating tank assembly 22 through the third port 73 may be sufficiently heated. Based on this, the drainage and water feeding of the heating tank assembly 22 share one opening. Therefore, the three-way tube 70 is designed, i.e., the water feeding and drainage of the heating tank assembly 22 share the third port 73, simplifying the structure.

Similar to the communication of the cooling tank assembly 21, the communication of the heating tank assembly 22 also adopts the connection in the insertion manner. The heating tank assembly 22 is connected to the first manifold 30 and the three-way tube 70 in an insertion manner, and the three-way tube 70 is connected to the first manifold 30 and the second manifold 40 in an insertion manner. In this way, communication between the second water inlet passageway 322 and the three-way tube 70, communication between the three-way tube 70 and the heating tank assembly 22, communication between the heating tank assembly 22 and the second water outlet passageway 332, and communication between the heating tank assembly 22 and the second drainage passageway 412 are realized.

In an exemplary embodiment of the present disclosure, as shown in FIG. 12, FIG. 13, FIG. 17, FIG. 18, and FIG. 23, the heating tank assembly 22 is provided with a heating-tank water outlet connector 6200 and a heating-tank water inlet and drainage connector 6100. The heating-tank water outlet connector 6200 is located at a top of the heating tank assembly 22. The heating-tank water inlet and drainage connector 6100 is located at the bottom of the heating tank assembly 22. The heating-tank water outlet connector 6200 and the heating-tank water inlet and drainage connector 6100 are in communication with an internal space of the heating tank assembly 22, respectively. The second water inlet passageway 322 is provided with a second water inlet connector 3221 at an end of the second water inlet passageway 3220 and has another end connected to the second water outlet 342. The second drainage passageway 412 is provided with a second drainage connector 4121 at an end of the second drainage passageway 412 and has another end in communication with the outside.

During assembly, the second water inlet connector 3221 is connected to the first port 71 of the three-way tube 70 in an insertion manner to be in communication with the first port 7100, allowing the water to flow from the second water inlet passageway 322 into the three-way tube 70. The heating-tank water inlet and drainage connector 6100 is connected to the third port 73 of the three-way tube 70 in an insertion manner to be in communication with the third port 73 of the three-way tube 7000, allowing the water to flow from the three-way tube 7000 into the heating tank assembly 22 to be heated into the hot water. The heating-tank water outlet connector 6200 is connected to the second water outlet connector 3321 in an insertion manner to be in communication with the second water outlet connector 3321, allowing the hot water to flow from the heating tank assembly 22 to the second water outlet 342. The second drainage connector 4121 is connected to the second port 72 of the three-way tube 70 in an insertion manner to be in communication with the second port 72 of the three-way tube 70, allowing the water in the heating tank assembly 22 to flow to the three-way tube 70 (to enter the three-way tube 7000 from the third port 73) and then flow to the second drainage passageway 412 to be drained to the outside.

It can be understood that a cooling process of the water by the cooling tank assembly 21 (including a water temperature change, an inflow and outflow of the water) affects an air pressure in the cooling tank assembly 21, and a heating process of the water by the heating tank assembly 22 (including the water temperature change, the inflow and outflow of the water) also affects an air pressure in the heating tank assembly 22. In order to make the cooling tank assembly 21 and the heating tank assembly 22 operate normally, as illustrated in FIG. 12, FIG. 13, FIG. 18 to FIG. 20, the first manifold 30 further has an exhaust passageway 35, i.e., the exhaust passageway 35, the water inlet passageway 32, and the water outlet passageway 33 are integrated on the first manifold 30. The cooling tank assembly 21 and the heating tank assembly 22 are in communication with the exhaust passageway 35 of the first manifold 30 other than a waterflow of the first manifold 30. In this way, balance of an internal air pressure and an external air pressure of the cooling tank assembly 21 and balance of an internal air pressure and an external air pressure of the heating tank assembly 22 can be achieved through the exhaust passageway 35, to ensure the normal operation of the cooling tank assembly 21 and the heating tank assembly 22.

For example, the exhaust passageway 35 includes a first air passageway 351 and a second air passageway 352. The first air passageway 351 is in communication with the cooling tank assembly 21, allowing the cooling tank assembly 21 to exhaust air through the first air passageway 351. The second air passageway 352 is in communication with the heating tank assembly 22, allowing the heating tank assembly 22 to exhaust air through the second air passageway 352. Since the cooling tank assembly 21 and the heating tank assembly 22 respectively occupy a predetermined space, by providing the first air passageway 351 and the second air passageway 352, the cooling tank assembly 21 and the heating tank assembly 22 may be made more flexible in arrangement and exhaust the air without interfering with each other.

Further, as illustrated in FIG. 12, FIG. 13, and FIG. 18 to FIG. 20, in some embodiments, the cooling tank assembly 21 is adapted to be connected to the first manifold 30 in an insertion manner, to enable the cooling tank assembly 21 to be in communication with the first air passageway 351. The heating tank assembly 22 is adapted to be connected to the first manifold 30 in an insertion manner, to enable the heating tank assembly 22 to be in communication with the second air passageway 352. In this way, it is facilitated that the cooling tank assembly 21 is in communication with the first air passageway 351 in the insertion manner, and the heating tank assembly 22 is in communication with the second air passageway 352 in the insertion manner, improving the assembly convenience.

In an exemplary embodiment of the present disclosure, the cooling tank assembly 21 is provided with a cooling-tank exhaust connector 5400 located at the top of the cooling tank assembly 21. The first air passageway 351 is provided with a first exhaust connector 3411 at an end of the first air passageway 351 and has another end in communication with the outside. The first exhaust connector 3411 is connected to the cooling-tank exhaust connector 5400 in an insertion manner, to realize the communication between the cooling tank assembly 21 and the first air passageway 351. The heating tank assembly 22 is provided with a heating-tank exhaust connector 6300 located at the top of the heating tank assembly 22. The second air passageway 352 is provided with a second exhaust connector 3421 at an end of the second air passageway 352 and has another end in communication with the outside. The second exhaust connector 3421 is connected to the heating-tank exhaust connector 6300 in an insertion manner to realize the communication between the heating tank assembly 22 and the second air passageway 352.

As illustrated in FIG. 12, in some embodiments, the exhaust passageway 35 (the first air passageway 351 and the second air passageway 352) is designed to be adjacent to the water receiving basin 31. By taking the first air passageway 351 as an example, a minimum distance between the first air passageway 351 and the water receiving basin 31 is smaller than or equal to 5 mm, which can be considered as the first air passageway 351 being adjacent to the water receiving basin 31. For example, an exhaust tail end of the exhaust passageway 35 may be designed to have a common wall with the water receiving basin 31, i.e., an exhaust tail end of the first air passageway 351 may have a common wall with the water receiving basin 31, and an exhaust tail end of the second air passageway 352 may have a common wall with the water receiving basin 31.

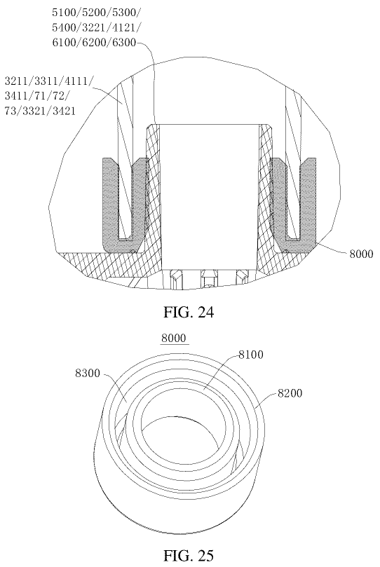

As shown in FIG. 24 and FIG. 25, in some embodiments, a sealing member 8000 is provided between the aforementioned two connected components in the insertion manner to form sealing. That is, the sealing member 8000 is provided between the cooling-tank water inlet connector 5100 and the first water inlet connector 3211, between the cooling-tank water outlet connector 5200 and the first water outlet connector 3311, between the cooling-tank drainage connector 5300 and the first drainage connector 4111, between the first port 71 of the three-way tube 70 and the second water inlet connector 3221, between the second port 72 of the three-way tube 70 and the second drainage connector 4121, between the third port 73 of the three-way tube 70 and the heating-tank water inlet and drainage connector 6100, between the heating-tank water outlet connector 6200 and the second water outlet connector 3321, between the cooling-tank exhaust connector 5400 and the first exhaust connector 3411, and/or between the heating-tank exhaust connector 6300 and the second exhaust connector 3421.

Further, continuing in combination with FIG. 24 and FIG. 25, the sealing member 8000 includes a first annular wall 8100 and a second annular wall 8200 surrounding the first annular wall 8100. The first annular wall 8100 has an end connected to an end of the second annular wall 8200 and another end separated from another end of the second annular wall 8200, to allow an open sandwiched cavity to be formed between the first annular wall 8100 and the second annular wall 8200. It is defined that one of the two connected components in the insertion manner is a first component and the other one of the two connected components in the insertion manner is a second component. The first component is inserted into the sandwiched cavity 8300, allowing the first annular wall 8100 to be located within the first component and the second annular wall 8200 to be located outside the first component. The second component is inserted into the first component and penetrates the first annular wall 8100. The first annular wall 8100 abuts against the first component and the second component, respectively. In this way, the first annular wall 8100 occurs between the first component and the second component to form sealing.

As an example, the cooling-tank water inlet connector 5100 is connected to the first water inlet connector 3211 in the insertion manner. The first water inlet connector 3211 is the first component. The cooling-tank water inlet connector 5100 is the second component. The first water inlet connector 3211 is inserted into the sandwiched cavity 8300. The first annular wall 8100 is located in the first water inlet connector 3211. The second annular wall 8200 is located outside the first water inlet connector 3211. The cooling-tank water inlet connector 5100 is inserted into the first water inlet connector 3211 and penetrates the first annular wall 8100. In this way, the first annular wall 8100 forms sealing between the first water inlet connector 3211 and the cooling-tank water inlet connector 5100.

As shown in FIG. 24 and FIG. 25, in some embodiments, the first component is in an interference fit with the second annular wall 8200. As the same example, the cooling-tank water inlet connector 5100 is connected to the first water inlet connector 3211 in the insertion manner. The first water inlet connector 3211 is the first component. The cooling-tank water inlet connector 5100 is the second component. The first water inlet connector 3211 is inserted into the sandwiched cavity 8300. Moreover, the second annular wall 8200 is in an interference fit with the first water inlet connector 3211 (the second annular wall 8200 surrounds the first water inlet connector 3211), forming a preliminary positioning and installation effect on the sealing member 8000. A position of the sealing member 8000 is not easy to change, facilitating the insertion of the cooling-tank water inlet connector 5100.

Further, in some embodiments, the first component is in a clearance fit with the first annular wall 8100. Still as the same example, the cooling-tank water inlet connector 5100 is connected to the first water inlet connector 3211 in the insertion manner. The first water inlet connector 3211 is the first component. The cooling-tank water inlet connector 5100 is the second component. The first water inlet connector 3211 is inserted into the sandwiched cavity 8300. Moreover, the first annular wall 8100 is in a clearance fit with the first water inlet connector 3211 (the first annular wall 8100 is located in the first water inlet connector 3211). When the cooling-tank water inlet connector 5100 is inserted into the first water inlet connector 3211 and penetrates the first annular wall 8100, the cooling-tank water inlet connector 5100 needs to squeeze the sealing member 8000 (the first annular wall 8100). Therefore, in this embodiment, it is designed that the first annular wall 8100 is in a clearance fit with the first annular wall 8100, which provides a predetermined space for the deformation of the sealing member 8000 (the first annular wall 8100), to prevent the sealing member 8000 from fracturing under significant compression, realizing effective radial sealing.

As illustrated in FIG. 13 and FIG. 14, in some embodiments, the water outlet passageway 33 further includes the third water outlet passageway 333 connected to one of the first water inlet passageway 321, the second water inlet passageway 322, and the water receiving basin 31. In this way, a normal temperature water outlet function is realized.

In an exemplary embodiment of the present disclosure, the third water outlet passageway 333 has an end connected to the one of the first water inlet passageway 321, the second water inlet passageway 322, and the water receiving basin 31 and another end connected to the third water outlet 343. In response to an end of the third water outlet passageway 333 being connected to the water receiving basin 31, when it is necessary to output the normal temperature water, the water in the water receiving basin 31 directly flows to the third water outlet 343 through the third water outlet passageway 333. In response to an end of the third water outlet passageway 333 being connected to the second water inlet passageway 322, when it is necessary to output the normal temperature water, the water in the water receiving basin 31 flows to the second water inlet passageway 322, then to the third water outlet passageway 333, and finally to the third water outlet 343 (in this case, a normal temperature water function and a hot water function share the second water inlet passageway 322). In response to an end of the third water outlet passageway 333 being connected to the first water inlet passageway 321, when it is necessary to output the normal temperature water, the water in the water receiving basin 31 flows to the first water inlet passageway 321, then to the third water outlet passageway 333, and finally to the third water outlet 343 (in this case, the normal temperature water function and a cold water function share the first water inlet passageway 321). In this way, a draining temperature of the normal temperature water can be avoided from being affected by the heating tank assembly 22 and the cooling tank assembly 21.

As shown in FIG. 6, FIG. 12, FIG. 13, and FIG. 22, in some embodiments, the first manifold 30 is disposed above the second manifold 40. The cooling tank assembly 21 is disposed between the first manifold 30 and the second manifold 40. The heating tank assembly 22 is disposed between the first manifold 30 and the second manifold 40. The water receiving basin 31 is disposed above the water inlet passageway 32 and the water outlet passageway 33.

The water pump 50 pumps water to the water receiving basin 31. When it is necessary to drain the cold water, the first water outlet 341 is turned on. Under the action of gravity, the water in the water receiving basin 3100 flows through the first water inlet passageway 321 into the cooling tank assembly 21, and the cooling tank assembly 21 cools the water flowing into the cooling tank assembly 21. As the water continues to flow into the cooling tank assembly 21, the cold water is transported to the first water outlet 341 through the first water outlet passageway 331 to be drained. When cleaning is required, the first drainage passageway 411 is opened. Under the action of gravity, the water in the cooling tank assembly 21 enters the first drainage passageway 411 and is drained.

The water pump 50 pumps water to the water receiving basin 31. When the hot water needs to be drained, the second water outlet 342 is opened. Under the action of gravity, the water in the water receiving basin 31 enters the three-way tube 70 through the second water inlet passageway 322, the water in the three-way tube 70 enters the heating tank assembly 22, and the heating tank assembly 22 heats the water entering it. As the water continues to enter the heating tank assembly 22, the hot water is delivered to the second water outlet 342 through the second water outlet passageway 332 to be drained. When cleaning is required, the second drainage passageway 412 is opened. Under the action of gravity, the water in the heating tank assembly 22 enters the second drainage passageway 412 to be drained.

The water pump 50 pumps water to the water receiving basin 31. When it is necessary to drain the normal temperature water, the third water outlet 343 is turned on. Under the action of gravity, he water in the water receiving basin 31 directly enters the third water outlet passageway 333, or enters the second water inlet passageway 322 and then the third water outlet passageway 333, or enters the first water inlet passageway 321 and then the third water outlet passageway 333, and is finally delivered to the third water outlet 343 to be drained.

As shown in FIG. 6 and FIG. 7, in some embodiments, the water pump 50 is disposed at a side of the first manifold 30 facing away from the second manifold 40. For example, the water pump 50 is fixedly connected to the side of the first manifold 30 facing away from the second manifold 40. In this way, the support of the water pump 50 is realized. Since the cooling tank assembly 21 and the heating tank assembly 22 are disposed between the first manifold 30 and the second manifold 40, with this arrangement, the water pump 50 may avoid occupying a space between the cooling tank assembly 21 and the heating tank assembly 22 and utilize the space more fully.

Similarly, as shown in FIG. 6 and FIG. 7, the functional module 20 includes an electronic control system, and the electronic control system controls the operation of the electricity-related components and is disposed at the side of the first manifold 30 facing away from the second manifold 40. For example, the electronic control system is fixedly connected to the side of the first manifold 30 facing away from the second manifold 40. In this way, the support for the electronic control system is realized, and the space between the cooling tank assembly 21 and the heating tank assembly 22 is prevented from being occupied. Moreover, even if the water leakage occurs in the first manifold 30, the water is also not easy to be in contact with the electronic control system and cause damage to the electronic control system.

As shown in FIG. 6 and FIG. 7, in some embodiments, the functional module 20 further includes the compressor 25. The heating tank assembly 22 is designed to be spaced apart from the second manifold 40. The compressor 25 is placed below the heating tank assembly 22. The compressor 25 may be fixedly connected to the second manifold 40, allowing the compressor 25 to be located between the heating tank assembly 22 and the second manifold 40. In this way, each component is more compact in arrangement to reduce space occupation as much as possible.

In some embodiments, the cooling tank assembly 21 is fixedly connected to the first manifold 30 and the second manifold 40, respectively. Since a volume of the cooling tank assembly 21 is relatively large, the cooling tank assembly 21 is fixedly connected to the first manifold 30 and the second manifold 40, which effectively realizes the fixation of the cooling tank assembly 21. Moreover, since the first manifold 30 is located above the second manifold 40, with this arrangement, the cooling tank assembly 21 may also support the first manifold 30 and the second manifold 40, improving structural stability. Further, it is worth noting that the cooling tank assembly 21 needs to be connected to the first manifold 30 and the second manifold 40 in the insertion manner, to realize the communication of the passageways. The cooling tank assembly 21 is fixedly connected to the first manifold 30 and the second manifold 40, respectively. In this way, it is ensured that the cooling tank assembly 21 and the first manifold 30 are connected in the insertion manner without being easily separated from each other, and that the cooling tank assembly 21 and the second manifold 40 are connected in the insertion manner without being easily separated from each other.

For example, as illustrated in FIG. 13, FIG. 17, and FIG. 19, the first manifold 30 is provided with a first connection portion 3510. The cooling tank assembly 21 is provided with a third connection portion 5610. The first connection portion 3510 is fixedly connected to the third connection portion 5610, realizing that the cooling tank assembly 21 is fixedly connected to the first manifold 30. The second manifold 40 is provided with a second connection portion 4200. The cooling tank assembly 21 is provided with a fourth connection portion 5620. The second connection portion 4200 is fixedly connected to the fourth connection portion 5620, realizing that the cooling tank assembly 21 is fixed to the second manifold 40. The fixed connection of the first connection portion 3510 and the third connection portion 5610, and the fixed connection of the second connection portion 4200 and the fourth connection portion 5620 are achieved in various manners, such as by welding, riveting, snap-fitting, or screwing. The first connection portion 3510 and the second connection portion 4200 may be snap holes, the third connection portion 5610 and the fourth connection portion 5620 may be snaps, and the snap holes and the snaps allow for a snap-fit connection. Alternatively, the first connection portion 3510 and the second connection portion 4200 may be fastener holes, and the third connection portion 5610 and the fourth connection portion 5620 may also be fastener holes, allowing for connections by a threaded fastener. In other embodiments of the present disclosure, other connection manners can be used as long as the required fixed connection are achieved in these connection manners.

As shown in FIG. 13 and FIG. 18, in some embodiments, the heating tank assembly 22 is fixedly connected to the first manifold 30. Since a size of the heating tank assembly 22 is smaller than a size of the cooling tank assembly 21, the heating tank assembly 22 may be fixedly connected to the first manifold 30, and the support for the heating tank assembly 22 may also be realized.

For example, the first manifold 30 is provided with a fifth connection portion 3520. The heat tank assembly 22 is provided with a sixth connection portion 6400. The fifth connection portion 3520 is fixedly connected to the sixth connection portion 6400. The fifth connection portion 3520 and the sixth connection portion 6400 are connected in various ways, such as by welding, riveting, snapping, and screwing. The fifth connection portion 3520 may be a snap, the sixth connection portion 6400 may be a snap hole, and the snap hole and the snap hole may be snap-fitted together. Alternatively, the fifth connection portion 3520 may be a fastening hole, the sixth connection portion 6400 may be a fastening hole, and the fifth connection portion 3520 and the sixth connection portion 6400 may be fastened by threading a threaded fastener. In other embodiments of the present disclosure, other connection manners can also be used.

As shown in FIG. 6, in some embodiments, the functional module 20 includes the support 60. The support 60 is a structure for mounting the first manifold 30 and the second manifold 40. The first manifold 30 and the second manifold 40 are fixedly connected to the support 60. Since the cooling tank assembly 21, the heating tank assembly 22, and the compressor 25 are disposed between the first manifold 30 and the second manifold 40, the water pump 50 and the electric control system are disposed on the first manifold 30. Therefore, the support 1100 allows for assembly of a modular design (including that the condenser 5700 of the functional module 20 may also be mounted on the support 1100), facilitating installation of the functional module 20 within the housing 10.

In descriptions of the present disclosure, descriptions with reference to the terms “an embodiment”, “some embodiments”, “examples”, “specific examples”, or “some examples” etc., mean that specific features, structure, materials, or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner. In addition, those skilled in the art can combine the different embodiments or examples and the features of the different embodiments or examples described in this specification without contradicting each other.

Although the embodiments of the present disclosure have been shown and described above, it can be understood that the above-mentioned embodiments are exemplary and should not be construed as limiting the present disclosure. For those of ordinary skill in the art, changes, modifications, replacements, and variants can be made to the above-mentioned embodiments within the scope of the present disclosure.

What is claimed is:

1. A bottom-loaded water dispenser, comprising a functional module and a second cavity disposed below the functional module, the second cavity being adapted to receive a water bucket, the functional module comprising:
a cooling tank assembly;
a heating tank assembly;
a water passageway assembly, the cooling tank assembly and the heating tank assembly being connected to the water passageway assembly; and
a water pump configured to pump water in the water bucket to the water passageway assembly.

2. The bottom-loaded water dispenser according to claim 1, further comprising:
a housing having a first cavity formed in the housing, the first cavity and the second cavity being spaced apart from each other, and the first cavity being located above the second cavity; and
a support disposed in the first cavity and connected to the housing,
wherein the functional module is located in the first cavity and integrated on the support; and
wherein the water passageway assembly has a water outlet.

3. The bottom-loaded water dispenser according to claim 2, wherein the water pump is located in the first cavity and connected to at least one of the water passageway assembly and the support.

4. The bottom-loaded water dispenser according to claim 2, the water passageway assembly comprises a first manifold, the first manifold having a water receiving basin, a water inlet passageway, a water outlet passageway, and the water outlet, wherein:
the water pump is configured to pump the water in the water bucket to the water receiving basin;
the water receiving basin is in communication with the cooling tank assembly through the water inlet passageway;
the water receiving basin is in communication with the heating tank assembly through the water inlet passageway;
the water outlet is in communication with the cooling tank assembly through the water outlet passageway; and
the water outlet is in communication with the heating tank assembly through the water outlet passageway.

5. The bottom-loaded water dispenser according to claim 4, wherein:
the water inlet passageway comprises a first water inlet passageway and a second water inlet passageway;
the water outlet passageway comprises a first water outlet passageway and a second water outlet passageway; and
a plurality of water outlets are provided and comprise a first water outlet and a second water outlet, wherein:
the water receiving basin is in communication with the cooling tank assembly through the first water inlet passageway;
the first water outlet is in communication with the cooling tank assembly through the first water outlet passageway;
the water receiving basin is in communication with the heating tank assembly through the second water inlet passageway; and
the second water outlet is in communication with the heating tank assembly through the second water outlet passageway.

6. The bottom-loaded water dispenser according to claim 5, wherein:
the plurality of water outlets further comprise a third water outlet; and
the water outlet passageway further comprises a third water outlet passageway, the water receiving basin being in communication with the third water outlet through the third water outlet passageway.

7. The bottom-loaded water dispenser according to claim 4, wherein the first manifold further has a water supply passageway, the water supply passageway being adapted to bring the water bucket in communication with an inlet of the water pump.

8. The bottom-loaded water dispenser according to claim 7, wherein:
the water supply passageway is connected to the water bucket through a water supply tube; and/or
the water supply passageway is directly connected to the inlet of the water pump.

9. The bottom-loaded water dispenser according to claim 4, wherein the first manifold further has an exhaust passageway, the cooling tank assembly and the heating tank assembly being in communication with the exhaust passageway.

10. The bottom-loaded water dispenser according to claim 9, wherein the exhaust passageway comprises a first air passageway and a second air passageway, the cooling tank assembly being in communication with the first air passageway, and the heating tank assembly being in communication with the second air passageway.

11. The bottom-loaded water dispenser according to claim 1, wherein a manifold assembly comprises:
a first manifold having a water receiving basin, a water inlet passageway, and a water outlet passageway; and
a second manifold having a drainage passageway adapted to pump water in the water bucket to the water receiving basin,
wherein the cooling tank assembly is adapted to be in communication with the water inlet passageway to receive the water from the water receiving basin, adapted to be in communication with the water outlet passageway to output refrigerated water, and further adapted to be in communication with the drainage passageway to drain water in the cooling tank assembly; and
wherein the heating tank assembly is adapted to be in communication with the water inlet passageway to receive the water from the water receiving basin, adapted to be in communication with the water outlet passageway to output heated water, and further adapted to be in communication with the drainage passageway to drain water in the heating tank assembly.

12. The bottom-loaded water dispenser according to claim 11, further comprising a door body adapted to expose or cover the second cavity.

13. The bottom-loaded water dispenser according to claim 11, wherein:
an inlet of the water pump is connected to a second water delivery hose, the second water delivery hose being connected to the first manifold; and
the first manifold is connected to a water supply tube adapted to extend into the water bucket, the second water delivery hose being in communication with the water supply tube.

14. The bottom-loaded water dispenser according to claim 11, wherein:
the water receiving basin is disposed above the water inlet passageway and the water outlet passageway;
the first manifold is disposed above the second manifold; and
the cooling tank assembly and the heating tank assembly are disposed between the first manifold and the second manifold.

15. The bottom-loaded water dispenser according to claim 14, wherein:
the water pump is disposed at a side of the first manifold facing away from the second manifold; and/or
the functional module further comprises an electronic control system disposed at the side of the first manifold facing away from the second manifold; and/or
the functional module further comprises a compressor disposed between the heating tank assembly and the second manifold.

16. The bottom-loaded water dispenser according to claim 11, wherein:
the water inlet passageway comprises a first water inlet passageway and a second water inlet passageway, the first water inlet passageway and the second water inlet passageway being in communication with the water receiving basin;
the water outlet passageway comprises a first water outlet passageway and a second water outlet passageway;
the drainage passageway comprises a first drainage passageway and a second drainage passageway;
the cooling tank assembly is adapted to be in communication with the first water inlet passageway to receive the water from the water receiving basin, adapted to be in communication with the first water outlet passageway to output the refrigerated water, and further adapted to be in communication with the first drainage passageway to drain the water in the cooling tank assembly; and
the heating tank assembly is adapted to be in communication with the second water inlet passageway to receive the water from the water receiving basin, adapted to be in communication with the second water outlet passageway to output the heated water, and further adapted to be in communication with the second drainage passageway to drain the water in the heating tank assembly.

17. The bottom-loaded water dispenser according to claim 16, wherein the water outlet passageway further comprises a third water outlet passageway connected to one of the water receiving basin, the first water inlet passageway, and the second water inlet passageway, the third water outlet passageway being adapted for output of water from the water receiving basin.

18. The bottom-loaded water dispenser according to claim 11, wherein the first manifold further has an exhaust passageway, the cooling tank assembly and the heating tank assembly being further adapted to be in communication with the exhaust passageway for exhausting.

19. The bottom-loaded water dispenser according to claim 18, wherein the exhaust passageway comprises a first air passageway and a second air passageway, the cooling tank assembly being adapted to be in communication with the first air passageway for exhausting, and the heating tank assembly being adapted to be in communication with the second air passageway for exhausting.

20. The bottom-loaded water dispenser according to claim 19, wherein:
the first air passageway is provided with a first exhaust connector at an end of the first air passageway, and the cooling tank assembly is provided with a cooling-tank-assembly exhaust connector, the cooling-tank-assembly exhaust connector being connected to the first exhaust connector in an insertion manner; and/or
the second air passageway is provided with a second exhaust connector at an end of the second air passageway, and the heating tank assembly is provided with a heating-tank-assembly exhaust connector, the heating-tank-assembly exhaust connector being connected to the second exhaust connector in an insertion manner.
